(19) United States
(12) Patent Application Publication
(10) Pub. No.: US 2025/0073921 A1
(43) Pub. Date: Mar. 6, 2025

(54) MORPHING END EFFECTOR TOOL

(71) Applicant: Align Technology, Inc., San Jose, CA (US)

(72) Inventors: René David Alfaro, El Paso, TX (US); Ricardo Robles Reyes, Ciudad Juárez (MX); Viswanath Meenakshisundaram, Santa Clara, CA (US)

(21) Appl. No.: 18/825,343

(22) Filed: Sep. 5, 2024

Related U.S. Application Data
(60) Provisional application No. 63/536,901, filed on Sep. 6, 2023.

(51) Int. Cl. B25J 15/00; B25J 11/00

(52) U.S. Cl. CPC B25J 15/0023; B25J 11/0055; B25J 11/008

(57) ABSTRACT

An end effector tool includes a fluid containing portion and an actuator. The fluid containing portion includes a distal wall located at a first distal end of the fluid containing portion and one or more sidewalls extending from the distal wall. The distal wall and the one or more sidewalls partially enclose an interior volume of the end effector tool. A fluid is disposed in the interior volume. The actuator is configured to apply energy to the fluid to change the fluid between a liquid state and a solid state. The fluid containing portion is to be placed over a dental product to cover the dental product with the fluid in the liquid state. The fluid is to secure the dental product responsive to the fluid being changed from the liquid state to the solid state.

### RELATED APPLICATION

This application claims benefit of U.S. Provisional Application No. 63/536,901, filed Sep. 6, 2023, the contents of which are incorporated by reference herein in their entirety.

### TECHNICAL FIELD

The technical field relates to the field of end effector tools and, in particular, to morphing end effector tools.

### BACKGROUND

For some applications, shells are formed over molds to achieve a negative of the mold. The shells are then removed from the molds to be further used for various applications. One example application in which a shell is formed around a mold and then later used is corrective dentistry or orthodontic treatment. In such an application, the mold is of a dental arch for a patient and the shell is a dental appliance (e.g., aligner to be used for aligning one or more teeth of the patient, orthodontic retainers, orthodontic splints, sleep appliances for mouth insertion, palatal expander, prefabricated template, etc.).

For some applications, dental appliances (e.g., aligners, other 3D printed dental appliances, etc.) are formed without a mold. The dental appliances may be manufactured using direct fabrication. Direct fabrication can include stereolithography, selective laser sintering, fused deposition modeling, 3D printing, continuous direct fabrication, multi-material direct fabrication, etc.

Molds and/or dental appliances may be formed using rapid prototyping equipment such as 3D printers, which may manufacture the molds and/or dental appliances using additive manufacturing techniques (e.g., stereolithography) or subtractive manufacturing techniques (e.g., milling).

### SUMMARY

Some example implementations of the present disclosure are summarized herein.

In a first implementation, an end effector tool comprises: a fluid containing portion comprising a distal wall located at a first distal end of the fluid containing portion and one or more sidewalls extending from the distal wall, the distal wall and the one or more sidewalls partially enclosing an interior volume of the end effector tool, a fluid being disposed in the interior volume; and an actuator configured to apply energy to the fluid to change the fluid between a liquid state and a solid state, wherein the fluid containing portion is to be placed over a dental product to cover the dental product with the fluid in the liquid state, and wherein the fluid is to secure the dental product responsive to the fluid being changed from the liquid state to the solid state.

A second implementation may further extend the first implementation. In the second implementation, the end effector tool further comprises a membrane secured to the one or more sidewalls at a second distal end of the fluid containing portion, wherein the membrane, the distal wall, and the one or more sidewalls enclose the interior volume of the end effector tool, and wherein the membrane is configured to deform around the dental product to cause the fluid to cover the dental product.

A third implementation may further extend the first or second implementations. In the third implementation, the fluid comprises a non-Newtonian fluid, and wherein the actuator comprises a mechanical vibration device configured to apply mechanical energy to the fluid to cause the fluid to be in the solid state.

A fourth implementation may further extend any of the first through third implementations. In the fourth implementation, the non-Newtonian fluid comprises one or more of a rheopectic material, Bingham plastic material, thixotropic material, or pseudo plastic material.

A fifth implementation may further extend any of the first through fourth implementations. In the fifth implementation, the fluid comprises a thermosensitive hydrogel, and wherein the actuator comprises a temperature adjustment device configured to adjust temperature of the fluid to cause the fluid to be in the solid state.

A sixth implementation may further extend any of the first through fifth implementations. In the sixth implementation, the fluid containing portion is a cup, and wherein the end effector tool further comprises a shaft secured to the distal wall of the cup to adjust location of the cup to move the dental product.

A seventh implementation may further extend any of the first through sixth implementations. In the seventh implementation, the product comprises the dental appliance that comprises one or more of a mold, dental appliance, aligner, palatal expander, or prefabricated template.

An eighth implementation may further extend any of the first through seventh implementations. In the eight implementation, the end effector tool forms one or more reservoirs configured to receive a portion of the fluid that has been displaced responsive to covering the dental product with the fluid in the liquid state.

A ninth implementation may further extend any of the first through eighth implementations. In the eighth implementation, the end effector tool is further configured to provide a vacuum pressure to secure the fluid in the liquid state in the interior volume of the end effector tool.

A tenth implementation may further extend any of the first through ninth implementations. In the tenth implementation, a controller is configured to adjust an amount of the energy applied to the fluid based on one or more properties of the product.

In an eleventh implementation, a method comprises: causing a fluid containing portion of an end effector tool to be placed over a dental product to cause fluid in a liquid state to cover the dental product, the fluid being disposed in the fluid containing portion; causing an actuator to change the fluid from the liquid state to a solid state to secure the dental product; and causing the actuator to change the fluid from the solid state to the liquid state to release the dental product.

A twelfth implementation may further extend the eleventh implementation. In the twelfth implementation, the method further comprises causing the end effector tool to transport the dental product to location responsive to the causing of the actuator to change the fluid to the solid state and prior to the causing of the actuator to change the fluid to the liquid state.

A thirteenth implementation may further extend the eleventh or twelfth implementations. In the thirteenth implementation, the fluid comprises a non-Newtonian fluid configured to change between the liquid state and the solid state, and wherein the actuator comprises a mechanical vibration device configured to apply mechanical energy to the fluid to change the fluid between the liquid state and the solid state.

A fourteenth implementation may further extend any of the first through thirteenth implementations. In the fourteenth implementation, the fluid comprises a thermosensitive hydrogel configured to change between the liquid state and the solid state, and wherein the actuator comprises a temperature adjustment device configured to change temperature of the fluid to change the fluid between the liquid state and the solid state.

In a fifteenth implementation, a system comprises: a plate comprising an upper surface configured to receive a mold associated with a dental arch of a patient; an end effector tool comprising: a fluid containing portion configured to be placed over the mold to cause fluid in a liquid state to cover the mold, the fluid being disposed in the fluid containing portion; and an actuator configured to: change the fluid from the liquid state to a solid state to secure the mold for transporting the mold; and responsive to the transporting of the mold, change the fluid from the solid state to the liquid state to place the mold on the plate; and a thermoforming chamber configured to thermoform a heated sheet of plastic to the mold that is disposed on the plate to generate a thermoformed sheet of plastic to form a dental appliance.

A sixteenth implementation may further extend the fifteenth implementation. In the sixteenth implementation, the system further comprises: a pallet configured to secure a sheet of plastic; and a heating section configured to heat the sheet of plastic to generate the heated sheet of plastic.

A seventeenth implementation may further extend the fifteenth or sixteenth implementations. In the seventeenth implementation, the system further comprises a cutting tool configured to trim the dental appliance from the thermoformed sheet of plastic.

An eighteenth implementation may further extend any of the fifteenth through seventeenth implementations. In the eighteenth implementation, the fluid comprises a non-Newtonian fluid configured to change between the liquid state and the solid state, and wherein the actuator comprises a mechanical vibration device configured to apply mechanical energy to the fluid to change the fluid between the liquid state and the solid state.

A nineteenth implementation may further extend any of the fifteenth through eighteenth implementations. In the nineteenth implementation, the fluid comprises a thermosensitive hydrogel configured to change between the liquid state and the solid state, and wherein the actuator comprises a temperature adjustment device configured to change temperature of the fluid to change the fluid between the liquid state and the solid state.

A twentieth implementation may further extend any of the fifteenth through nineteenth implementations. In the twentieth implementation, the end effector tool is configured to secure the dental appliance for one or additional operations.

### BRIEF DESCRIPTION OF THE DRAWINGS

The present invention is illustrated by way of example, and not by way of limitation, in the figures of the accompanying drawings.

FIG. 1A-B illustrate dental appliance manufacturing systems, according to certain embodiments.

FIGS. 2A-B illustrate end effector tools, according to certain embodiments.

FIGS. 3A-F illustrate end effector tools, according to certain embodiments.

FIGS. 4-5 illustrate flow diagrams for methods associated with dental appliances, according to certain embodiments.

FIG. 6 illustrates a block diagram of an example computing device, according to certain embodiments.

FIG. 7A illustrates a tooth repositioning appliance, according to certain embodiments.

FIG. 7B illustrates a tooth repositioning system, according to certain embodiments.

FIG. 7C illustrates a method of orthodontic treatment using a plurality of appliances, according to certain embodiments.

FIG. 8 illustrates a method for designing an orthodontic appliance, according to certain embodiments.

FIG. 9 illustrates a method for digitally planning an orthodontic treatment, according to certain embodiments.

### DETAILED DESCRIPTION

Described herein are embodiments of morphing end effector tools. An end effector tool may be a tool that is used to secure, position, transport, and/or place one or more products. For example, an end effector tool may secure a mold, transport the mold, and place the mold on a plate to form a dental appliance on the mold. The morphing end effector tool may be used to secure a product, such as a mold and/or a dental appliance (e.g., produced using the mold, three-dimensionally (3D) printed, etc.). Dental appliances may be polymeric dental appliances (also referred to as an aligner, shell, plastic aligner, plastic shell, appliance, orthodontic appliance, orthodontic retainer, orthodontic splint, sleep appliance for mouth insertion, orthodontic retainers, orthodontic splints, palatal expander, prefabricated template, etc.).

Conventionally, producing dental appliances using 3D printers (e.g., directly printing the dental appliance) and/or thermoforming processes (e.g., forming the dental appliance on a mold) includes using a mechanical gripper for mold and dental appliance manipulation between operations. The mechanical gripper secures (e.g., picks) the mold or dental appliance using a set of two or more specific, geometrically set points for manipulation. For example, a mold and/or dental appliance may be produced to have excess material (e.g., a tab, a protrusion, etc.) for the mechanical gripper to secure. This causes waste of material to form the protrusions and additional manufacturing processes to form the protrusions. If the protrusions are not produced correctly, the mechanical gripper may not properly secure the mold or dental appliance which causes errors in the manufacturing processes.

Embodiments described herein are directed to morphing end effector tools.

In some embodiments, an end effector tool (e.g., morphing end effector tool) includes a fluid containing portion (e.g., cup forming a cavity) and an actuator. In some embodiments, the fluid containing portion (e.g., cup) includes a distal wall located at a first distal end of the fluid containing portion and one or more sidewalls extending from the distal wall. The distal wall and the one or more sidewalls partially enclose an interior volume (e.g., cavity) of the end effector tool. A fluid is disposed in the interior volume.

The actuator is configured to apply energy to the fluid to change the fluid between a liquid state and a solid state. The fluid containing portion is to be placed over a product (e.g., mold, dental appliance) to cover the product with the fluid in the liquid state (e.g., with a membrane of the end effector tool between the fluid and the product). The fluid is to secure the product responsive to the fluid being changed from the liquid state to the solid state.

In some embodiments, the fluid includes a non-Newtonian fluid and the actuator includes a mechanical vibration device configured to apply mechanical energy to the fluid to cause the fluid to be in the solid state. In some embodiments, the fluid includes a thermosensitive hydrogel and wherein the actuator includes a temperature adjustment device configured to adjust temperature of the fluid to cause the fluid to be in the solid state.

Aspects of the present disclosure result in technological advantages of significant reduction in wasted plastic, significant increase in throughput, and significant improvement in quality. By using the end effector tool, the present disclosure results in being able to move products (e.g., mold, dental appliance, etc.) that do not have specially made protrusions compared to conventional mechanical grippers that require protrusions to move the products. This provides the present disclosure with less wasted material, less manufacturing processes, less errors in manufacturing, and increased throughput.

The present disclosure discusses a fluid that can change between a liquid state and a solid state. Liquid state may be a semi-liquid state, substantially liquid state, a state that allows the fluid to deform around a product (e.g., mold, dental appliance, dental product), etc. The solid state may be a gel state, a substantially solid state, a semi-solid state, a state that allows the fluid to secure a product (e.g., mold, dental appliance, dental product) without the product falling, etc.

Although in some embodiments, the present disclosure discusses using a fluid that is shear thickening where energy is added to change the fluid from a liquid state to a solid state (e.g., to secure a product), in some embodiments, the present disclosure may use a fluid that is shear thinning where energy is added to change the fluid from a solid state to a liquid state (e.g., to release a product). Changing from a liquid state to a solid state may include causing molecular arrangement to hold weight (e.g., a product such as a mold or a dental appliance) without the product falling under gravity.

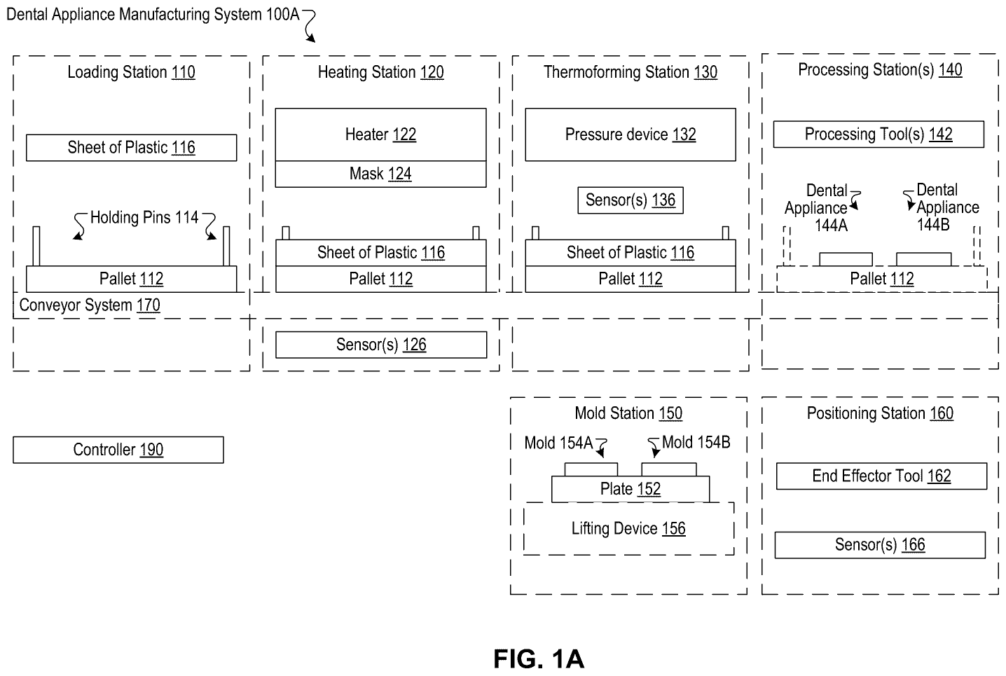

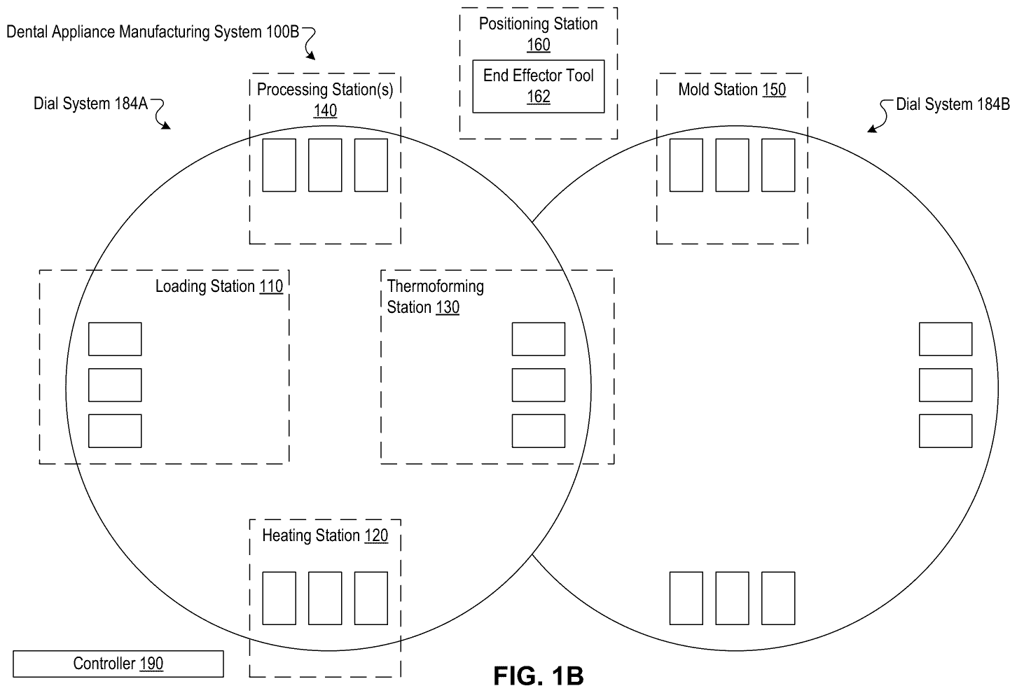

FIGS. 1A-B illustrate dental appliance manufacturing systems 100A-B (hereinafter dental appliance manufacturing system 100), according to certain embodiments. Dental appliance manufacturing system 100 may include one or more of loading station 110, heating station 120, thermoforming station 130, processing station 140, and mold station 150.

In some embodiments, dental appliance manufacturing system 100 may not include all of the stations shown in FIGS. 1A-B. In some examples, dental appliance manufacturing system 100 produces dental appliances 144 by thermoforming sheets of plastic 116 over molds 154 (e.g., using heating station 120 and/or thermoforming station 130). In some embodiments, dental appliance manufacturing system 100 produces dental appliances 144 and/or molds 154 by direct fabrication (e.g., 3D printing, does not include heating station 120 and/or thermoforming station 130, etc.).

In some embodiments, one or more stations (e.g., additional stations) may be included, before, after, and/or between the stations illustrated in FIGS. 1A-B. In some embodiments, one or more of the stations shown in FIGS. 1A-B may be combined into a single station. In some embodiments, there may be multiple of the same type of station. In some examples, dental appliance manufacturing system 100 includes multiple positioning stations 160 (e.g., a positioning station for positioning molds 154 and a positioning station for positioning dental appliances 144). In some examples, dental appliance manufacturing system 100 includes multiple processing stations 140 (e.g., a trimming station, a marking station, laser operation station, etc.).

In some embodiments, dental appliance manufacturing system 100 is related to producing products (e.g., forming molds 154 and/or dental appliances 144, thermoforming process system for dental appliances 144) that adjusts dynamically to different input geometries. The dental appliance manufacturing system 100 optimizes material utilization to produce the products (e.g., allows maximization of material and resources by mechanisms adjustment during the forming cycle). Based on the input geometry, the dental appliance manufacturing system 100 (e.g., the dynamic forming system) determines and adjusts the material, reconfiguring the dimensions and behavior of one or more components of the dental appliance manufacturing system 100 to create products (e.g., molds 154, dental appliances 144). The dental appliance manufacturing system 100 provides the ability to use different material geometries for producing products (e.g., thermoforming, direct fabrication), whether manually or automatically.

In some embodiments, one or more components (e.g., pallet 112) are transported via a conveyor system 170 (e.g., see FIG. 1A) through one or more of loading station 110, heating station 120, thermoforming station 130, procession station(s) 140, and/or mold station 150. The conveyor system 170 may be a conveyor belt, chain conveyor system, and/or the like. The pallets 112 may be chain conveyor pallets.

In some embodiments, one or more stations (e.g., loading station 110, heating station 120, thermoforming station 130, procession station(s) 140, and/or mold station 150, etc.) are rotated (e.g., via a dial system 184A of FIG. 1A) and one or more components (e.g., inspection station, mold station 150, molds 154) are rotated (e.g., via dial system 184B of FIG. 1B) to interface with each other.

At loading station 110, a pallet 112 including holding pins 114 and/or a sheet of plastic 116 may be configured and/or selected. At loading station 110, the sheet of plastic 116 may be secured to the pallet 112 via the holding pins 114 (e.g., the holding pins pierce the sheet of plastic 116).

At heating station 120, heater 122 may heat the sheet of plastic 116 secured to the pallet 112. In some embodiments, mask 124 is disposed between the heater 122 and the sheet of plastic 116 (e.g., to provide a substantially thermally isolated environment for heating the sheet of plastic 116).

At thermoforming station 130, a pressure device 132 may thermoform the heated sheet of plastic 116 onto the molds 154. In some embodiments, the molds 154 are secured to a plate 152 that is lifted via a lifting device 156 to interface with the heated sheet of plastic 116 for the thermoforming. In some embodiments, the molds 154 and sheet of plastic 116 are secured to the same component (e.g., pallet 112, plate 152).

In some embodiments, molds 154 are generated based on digital models associated with a dental arch of a user. In some embodiments (e.g., at an inspection station), one or more sensors (e.g., imaging device) are used to determine whether each mold 154 matches a corresponding digital model. Controller 190 may determine, based on sensor data, whether molds 154 match corresponding digital models and which molds 154 are to be used to produce dental appliances 144 (e.g., two or more molds 154 that are to be used for simultaneous thermoforming of dental appliances 144). The controller 190 may determine (e.g., based on one or more images or other sensor data provided by sensors) an identifier of the mold 154 (e.g., via optical character recognition (OCR), reading a bar code, reading a quick response (QR) code, reading an asset tag, reading a radio frequency identification (RFID) tag, reading a near-field communication (NFC) tag, etc.). The controller 190 may identify a digital model based on the identifier. The controller 190 may compare the geometry of the mold 154 with the digital model to determine whether the dimensions of the mold 154 match the dimensions of the digital model within a threshold value (e.g., meet threshold difference of dimensions). Responsive to the controller 190 determining the mold 154 matches the digital model, controller 190 causes the mold 154 to be used for generating a dental appliance 144. Responsive to the mold not matching the digital model, controller 190 causes a corrective action to be performed (e.g., discard the mold 154, prevent the mold 154 from being used for generating a dental appliance 144, etc.).

The controller 190 may identify two or more molds 154 that are to be used for simultaneous thermoforming of dental appliances 144 (e.g., responsive to the molds 154 matching corresponding digital models). The controller 190 may identify the molds 154 for simultaneous thermoforming of dental appliances 144 that would use the least amount of material, energy, and/or time per dental appliance. In some examples, the molds 154 that are identified for simultaneous thermoforming of dental appliances are similarly sized.

An end effector tool 162 (e.g., morphing end effector tool, of mold station 150) may cause the molds 154 to be positioned on a plate 152 (e.g., of mold station 150) to minimize use of material while maintaining clearances around the molds 154. In some embodiments, the plate 152 is lifted by a lifting device 156 to interface with the heated sheet of plastic 116 in the thermoforming station 130.

Subsequent to the thermoforming of the heated sheet of plastic 116, one or more processing tools of one or more processing stations 140 may perform operations (e.g., on the thermoformed sheet of plastic 116, on dental appliance 144) to generate the dental appliances 144 to be used by a patient. The operations may include one or more of trimming, marking, laser processing, imaging, testing, packaging, etc. The end effector tool 162 may move products (e.g., thermoformed sheet of plastic 116, dental appliances 144) for the performance of the operations. An end effector tool 162 may provide a product to another end effector tool 162 to secure a product in a correct position.

In some embodiments, end effector tool 162 may be a morphing end effector tool. The end effector tool 162 may include a fluid containing portion (e.g., cup forming a cavity) and an actuator. In some embodiments, the fluid containing portion (e.g., cup) includes a distal wall located at a first distal end of the fluid containing portion and one or more sidewalls extending from the distal wall. The distal wall and the one or more sidewalls partially enclose an interior volume (e.g., cavity) of the end effector tool. A fluid is disposed in the interior volume.

The actuator is configured to apply energy to the fluid to change the fluid between a liquid state and a solid state. The fluid containing portion is to be placed over a product (e.g., mold 154, dental appliance 144) to cover the product with the fluid in the liquid state (e.g., with a membrane of the end effector tool between the fluid and the product). The fluid is to secure the product responsive to the fluid being changed from the liquid state to the solid state.

In some embodiments, the fluid includes a non-Newtonian fluid and the actuator includes a mechanical vibration device (e.g., vibrator, physical oscillator, create shear stress event at molecule level, etc.) configured to apply mechanical energy to the fluid to cause the fluid to be in the solid state. In some embodiments, the actuator moves the entire end effector tool 162 to move the fluid. In some embodiments, the actuator moves (e.g., spins, agitates, shakes, rotating a rotary disk in the fluid, spin a turbine in the fluid, moves gas (e.g., bubbles, air, compressed air, inert gas, etc.) through the fluid, etc.) the fluid within the end effector tool.

In some embodiments, the fluid includes a thermosensitive hydrogel and wherein the actuator includes a temperature adjustment device configured to adjust temperature of the fluid to cause the fluid to be in the solid state (e.g., heat the fluid to cause it to be in solid state, the fluid is in liquid state at about 10 degrees Celsius and is in solid state at about 30 degrees Celsius).

In some embodiments, the fluid includes a ferrofluid (e.g., liquid that is attracted to poles of a magnet, includes nanoscale ferromagnetic or ferrimagnetic particles suspended in a carrier fluid, polymer resins that includes polymer stacked with ferro ions, glass with ferro coating). The actuator may increase the magnetic field and/or electric field to cause the particles in the fluid to line up (e.g., tune the polymer particles along magnetic field) to be in a more solid state and the actuator may decrease the magnetic field and/or electric field to cause the fluid to be in a more liquid state.

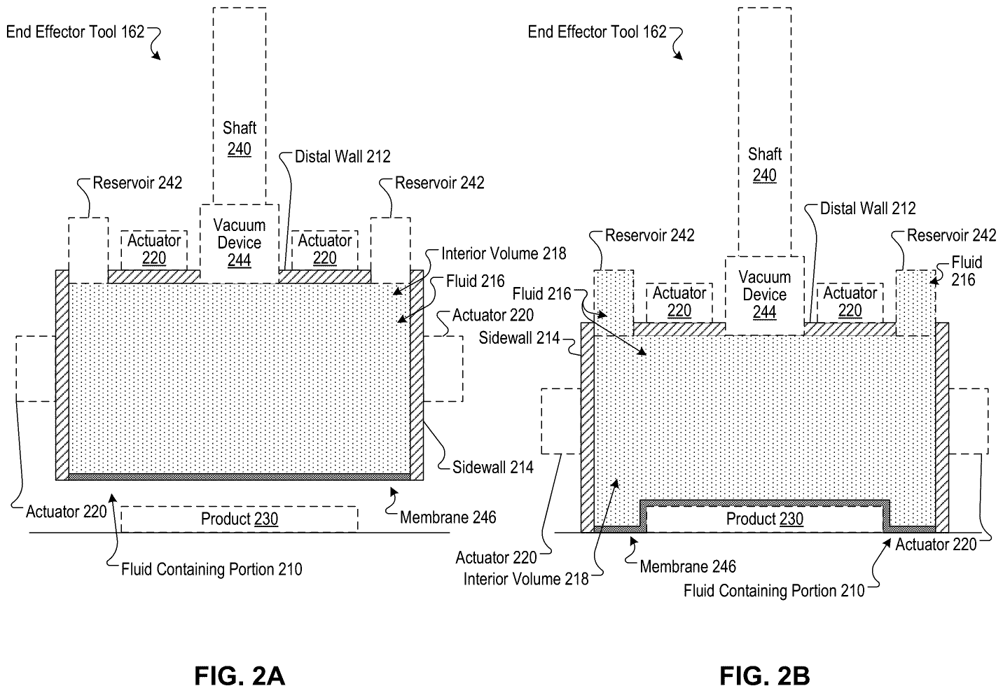

In some embodiments, controller 190 may control one or more end effector tools 162 and/or robots to secure molds 154, secure molds 154 to plate 152, secure sheet of plastic 116 (e.g., activate vacuum to pick up sheet of plastic 116), secure sheet of plastic 116 to pallet 112 (e.g., push the sheet of plastic 116 onto the holding pins 114 and deactivate vacuum), etc. In some embodiments, controller 190 may control one or more adjustment devices (e.g., servo motors, pneumatic devices) to adjust size of one or more of pallet 112, mask 124, heater 122, pressure device 132, plate 152, lifting device 156, and/or the like. In some embodiments, the controller 190 determines an amount of energy to apply to the end effector tool 162 to pick up a product (e.g., product 230 of FIGS. 2A-B) and causes the end effector tool 162 to use that amount of energy. In some embodiments, the controller 190 determines the amount of energy based on one or more parameters of the product, such as size of the product, weight of the product, roughness of surface of the product, roughness of surface of the membrane (e.g., membrane 246 of FIGS. 2A-B), type of fluid (e.g., fluid 216 of FIGS. 2A-B), type of product, etc. In some embodiments, the controller 190 receives one or more of the parameters via user input (e.g., product size, product weight, product surface roughness, membrane surface roughness, type of fluid, type of product, etc.). In some embodiments, the controller 190 reads an identifier of the product and determines one or more of the parameters (e.g., product size, product weight, product surface roughness, type of product, etc.) based on the identifier. In some embodiments, the controller 190 receives sensor data (e.g., imaging data, weight data, etc.) and determines the parameters (e.g., product size, product weight, product surface roughness, type of product, etc.) based on the sensor data.

In some embodiments, the amount of energy may be adjusted for each product or group of products (e.g., different amount of energy for molds vs aligners) based on weight, shape, etc. In some embodiments, the amount of energy may be adjusted dynamically for each product or set of products based on a table or database for the type of products that are to be picked up.

Responsive to the sheet of plastic 116 being secured to the pallet 112 in loading station 110, the sheet of plastic 116 may remain secured to the pallet 112 during heating via the heating station 120 and during thermoforming via the thermoforming station 130. In some embodiments, the pallet 112 has an upper surface that has a substantially rectangular surface area that forms four corners. The pallet 112 may include a holding pin 114 on the upper surface at each corner. The pallet 112 may include a holding pin 114 on the upper surface at a midpoint between each set of adjacent corners and/or at other positions along a perimeter of the pallet 112. The pallet 112 may have multiple holding pins 114 (e.g., six holding pins, eight holding pins) on the upper surface of the pallet 112 in some embodiments. The holding pins may have sharp points and may pierce the sheet of plastic 116 to secure the sheet of plastic 116 in embodiments.

After the loading station 110, the controller 190 (e.g., via conveyor system 170) may move pallet 112 to the heating station 120. The heating station 120 may include a heater 122 and a mask 124 (e.g., heater mask, heat mask). The heater 122 may be a ceramic heater, a convection oven, or an infrared heater in embodiments. The mask 124 may be heat resistant up to about 500° F. in embodiments. The mask 124 may be an insulator. The mask 124 may not adhere to the sheet of plastic 116 when the mask 124 and sheet of plastic 116 are heated. The mask may include polytetrafluoroethylene (PTFE) (e.g., Teflon™) in some embodiments. Other materials that are heat resistant, have low thermal conductivity, and that will not adhere to the plastic sheet may also be used.

In some embodiments, the heating station 120 includes one or more heaters 122 (e.g., three heaters, four heaters, heating elements), where each heater 122 (e.g., heating element, infrared heater) heats a corresponding zone. The heating station 120 may include one or more sensors 126 (e.g., to measure temperature). In some embodiments, there is at least one sensor 126 per heater 122 (e.g., at least one sensor 126 per zone). A sensor 126 may be located below each heater 122 (e.g., below the sheet of plastic 116). The sensors 126 may determine the temperature of the sheet of plastic 116 and/or the air around the sheet of plastic 116. A heating profile of the sheet of plastic 116 may be determined based on sensor data from the sensors 126.

In some embodiments, one or more sensors 126 may be disposed in the heating station 120 (e.g., in the heating chamber, above the sheet of plastic 116, etc.). In some embodiments, a corresponding sensor 126 is located above or below each corner of the sheet of plastic 116 (e.g., within the heating space, within the interior perimeter of the mask 124). In some embodiments, one or more sensors 126 are located above or below a middle portion of the sheet of plastic 116 (e.g., between a first mold and a second mold).

In some embodiments, the sensors 126 may be disposed below the sheet of plastic 116. One or more sensors 126 may be disposed in a first plane and the sheet of plastic 116 may be disposed in a second plane. The second plane may be substantially parallel to the first plane. The second plane may be a distance above the first plane. The distance between a first sensor 126 and a second sensor 126 may be less than the distance between the first plane and the second plane. In some embodiments, the distance between a first sensor 126 and a second sensor 126 is about one tenth the distance between the first plane and the second plane (e.g., sensor spacing is about one tenth the spacing between a sensor 126 and the sheet of plastic 116).

Controller 190 (e.g., processing device) may receive the sensor data from the sensors 126. The controller 190 may determine whether one or more temperatures associated with the sheet of plastic 116 meet one or more threshold values (e.g., high enough of temperature, not too high of temperature, total time of heating, rate of increase of temperature, temperature in each of the zones is substantially the same, etc.). Responsive to determining that the one or more temperatures associated with the sheet of plastic 116 meet the one or more threshold values, the controller 190 may allow the heated sheet of plastic continue being formed into an aligner. Responsive to determining that one or more temperatures associated with the sheet of plastic 116 do not meet one or more threshold values (e.g., uneven temperature, overheating, underheating, etc.), the controller 190 may perform a corrective action. A corrective action may include one or more of causing the heated sheet of plastic 116 to be discarded, causing the sheet of plastic 116 to be reheated, recalibrating the heaters 122, interrupting one or more components (e.g., heaters 122) of the dental appliance manufacturing system 100, providing an alert, changing the manufacturing parameters (e.g., controlling power fed to the heaters 122, controlling the heat to be in an acceptable range, controlling total time of heating, etc.), and/or the like.

The heating station 120 may move (e.g., via a pneumatic cylinder of the heating station 120) the mask 124 to interface with the sheet of plastic 116 on the pallet 112. The mask 124 may include features so that the mask 124 avoids interfacing with the holding pins 114 while the mask 124 surrounds the sheet of plastic 116. The mask 124 may surround the sheet of plastic 116 to minimize heat transfer from the heating station 120 to other sheets of plastic 116. The heater 122 may heat the sheet of plastic 116 to about 320 to about 350° F. (e.g., about 336° F.) without hanging of the sheet of plastic 116 (e.g., without sagging portions of the sheet of plastic) by using the mask 124. For example, the mask 124 may surround a perimeter of the sheet of plastic 116 and provide a force sandwiching the sheet of plastic 116 between the mask 124 and the pallet 112. The force may be applied approximately uniformly about the perimeter of the sheet of plastic 116 and may prevent or mitigate sagging and/or warping of the sheet of plastic 116 during the heating process. By avoiding generation of hanging or sagging portions of the sheet of plastic 116, air leaks may be avoided during the thermoforming. The mask 124 may be removed from the sheet of plastic 116 after the heating is completed.

After the heating station 120, the controller 190 (e.g., via conveyor system 170) may move the pallet 112 (e.g., with the heated sheet of plastic 116 secured to the pallet 112 via the holding pins 114) to the thermoforming station 130. The thermoforming station 130 may include a pressure device 132. In some embodiments, the pressure device 132 may be lowered to interface with at least a portion (e.g., of an upper surface of the heated sheet of plastic 116 and/or of an upper surface of the pallet 112 proximate the perimeter of the pallet 112). Molds 154 (e.g., at least a first mold 154A and a second mold 154B) may be secured to a plate 152 that is disposed on a lifting device 156. The pallet 112 may form a border, where the molds 154A-B and/or plate 152 may pass through the pallet (e.g., the pallet 112 creates a channel from the lower surface to the upper surface of the pallet 112 sized for the molds 154 and/or plate 152 to pass through the channel).

The lifting device 156 may lift the molds 154A-B and plate 152 to interface with a lower surface of the heated sheet of plastic 116 in the thermoforming station 130. The pressure device 132 may maintain a pressure level (e.g., high pressure, lower pressure, vacuum, substantially vacuum, etc.) at the upper surface of the heated sheet of plastic 116. The lifting device 156 may push the molds 154A-B against the lower surface of the heated sheet of plastic 116 to thermoform the heated sheet of plastic 116 to form aligners. Subsequent to thermoforming the heated sheet of plastic 116, the lifting device 156 may lower to allow the conveyor system 170 to move the pallet 112 and thermoformed sheet of plastic 116 out of the thermoforming station 130. The thermoforming station 130 may include one or more sensors 136. The controller 190 may receive sensor data from the sensors 136 to configure the pressure device 132 (e.g., adjust size of the cup of the pressure device 132, adjust pressure value provided by the pressure device 132, etc.).

After the thermoforming station 130, the thermoformed sheet of plastic 116 may be moved (e.g., via conveyor system 170) to other sections of the dental appliance manufacturing system 100 (e.g., one or more processing stations 140) for one or more of reading identifiers on the dental appliances, marking the dental appliances, dividing the dental appliances, trimming the dental appliances, etc.

The conveyor system 170 may continue to move pallets 112 from the loading station 110, to the heating station 120, to the thermoforming station 130, and to one or more processing stations 140 to produce products in parallel (e.g., simultaneously, on the same plate 152). For example, there may be a pallet 112 in the loading station 110, pallet 112 in the heating station 120, and a pallet 112 in the thermoforming station 130 at substantially the same time. In some embodiments, one or more end effector tools 162 are used to move products between one or more stations.

Some embodiments are discussed with reference to dynamically generating one or more dental appliances 144 (e.g., using mold 154A and mold 154B to form dental appliances 144 at substantially the same time). However, it should be understood that in some embodiments more than two dental appliances may be formed together using a single sheet of plastic. For example, three dental appliances, four dental appliances, five dental appliances, etc. may be formed in parallel on a single sheet of plastic. Additionally, embodiments are discussed with reference to the simultaneous thermoforming of multiple dental appliances. It should be understood that in some embodiments there may be a slight delay between the beginning of thermoforming a first dental appliance and thermoforming a second dental appliance and/or between the ending of thermoforming a first dental appliance and ending of thermoforming a second dental appliance. For example, mold 154A may be slightly vertically offset from mold 154B, which may cause the thermoforming of a first dental appliance by mold 154A to start and end at a slightly different time from the thermoforming of a second dental appliance by mold 154B. Accordingly, it should be understood that embodiments that are discussed with reference to simultaneous processing or manufacturing also include parallel processing or manufacturing that may not be simultaneous.

FIG. 1B illustrates a dental appliance manufacturing system 100B, according to certain embodiments. Elements with the same or similar numbering may have the same or similar functionality as those described in FIG. 1A. The dental appliance manufacturing system 100B may include a loading station 110, a heating station 120, a thermoforming station 130 (e.g., one or more thermoforming chambers), one or more processing stations 140 and/or a mold station 150, and/or one or more processing stations 140. One or more dial systems 184 may be used to form products (e.g., molds 154, dental appliances 144). A dial system 184A may rotate to move pallets 112 through the loading station 110, heating station 120, thermoforming station 130, and/or one or more processing stations 140. A dial system 184B may be used to load the plate 152 and/or molds 154 onto a lifting device 156 (e.g., positioning the molds 154 via mold station 150). In some embodiments, two or more of the loading station 110, heating station 120, thermoforming station 130, and/or one or more processing stations 140 may be combined. In some embodiments, additional stations may be included before, after, or during the loading station 110, heating station 120, thermoforming station 130, mold station 150, and/or one or more processing stations 140.

In some embodiments, positioning station 160 includes one or more end effector tools 162. The one or more end effector tools 162 may move one or more products (e.g., mold 154, dental appliance 144) to and/or from one or more stations. In some examples, end effector tool 162 places molds 154 on mold station 150. In some examples, end effector tool 162 removes dental appliances 144 from processing station 140.

In some embodiments, the dial system 184A is configured to receive different sizes of pallets 112 (e.g., three sizes of pallets). Each pallet 112 may be configured for one or more molds (e.g., two molds). A size of pallet 112 may be selected and/or adjusted based on the size of the largest mold to be used with the pallet 112. Responsive to the largest mold to be used with the pallet 112 meeting a first threshold size, a first size of pallet 112 may be selected. For each size of pallet 112, there may be a corresponding size of sheet of plastic 116, a corresponding configuration of heaters 122, a corresponding size of mask 124, a corresponding pressure device 132, a corresponding plate 152, a corresponding lifting device 156, and/or the like.

In some embodiments, groups of two or more pallets 112 (e.g., three pallets 112) of different sizes are located on the dial system 184A proximate each other. Responsive to the dial system 184A rotating, a first group of the two or more pallets 112 is moved into the loading station 110. Responsive to the largest mold to be used meeting a threshold size, a particular size of sheet of plastic 116 is placed on a particular size of pallet 112.

After securing the sheet of plastic 116 to the pallet 112, the dial system 184A is rotated and the first group of two or more pallets 112 of different sizes is moved into the heating station 120. A heater 122 and mask 124 are moved to heat the sheet of plastic 116 secured to the pallet 112. In some embodiments, the same heater 122 and mask 124 are used to heat a sheet of plastic 116 secured to any of the two or more pallets 112. In some embodiments, there are three heaters 122 and three masks 124 that each correspond to a different sized pallet 112 and only the heater 122 above the pallet 112 that is securing a sheet of plastic 116B is actuated (e.g., lowered, caused to perform a heating function, etc.).

After heating the sheet of plastic 116 that is secured to the pallet 112, the dial system 184A is rotated and the first group of two or more pallets 112 of different sizes is moved into the thermoforming station 130. The thermoforming station may include the same number of thermoforming stations 130 (e.g., thermoforming chambers), pressure devices 132, plates 152, and/or lifting devices 154 as the number of pallets 112. Each thermoforming station 130, pressure device 132, plate 152, and/or lifting device 156 may be sized for the corresponding pallet 112. In some embodiments, only the thermoforming station 130, pressure device 132, and/or lifting device 156 corresponding to the pallet 112 securing a heated sheet of plastic 116 are actuated. A single lifting device 156 may be used for the two or more pallets 112. In some embodiments, the lifting device 156 is configured to receive and lift two or more plates 152, each sized for a corresponding pallet 112 (e.g., all two or more plates 152 are lifted at the same time by the lifting device 156). In some embodiments, the lifting device 156 is configured to receive a single plate 152 and move the plate 152 to the corresponding pallet 112 that is securing a sheet of plastic. In some embodiments, the thermoforming station 130 has two or more thermoforming chambers. In some embodiments, the thermoforming station 130 has a single thermoforming station 130 that is aligned with the pallet 112 that is securing a sheet of plastic 116.

After thermoforming the heated sheet of plastic 116 that is secured to the pallet 112, the dial system is rotated and the first group of two or more pallets 112 of different sizes is moved into the one or more processing stations 140. The one or more processing stations 140 may read one or more identifiers (e.g., patient identifier (PID, stage, etc.), laser mark the thermoformed sheet of plastic 116 (e.g., dental appliance), trim the one or more dental appliances form the thermoformed sheet of plastic 116, unload the thermoformed sheet of plastic 116 (e.g., dental appliances) from the plate 152, and/or the like. In some embodiments, the one or more processing stations 140 may include one or more substations and the dial system 184A may be rotated to move the first group of two or more pallets 112 from one substation to another. For example, one or more identifiers of the thermoformed sheet of plastic 116 may be read at a first substation, the dial system 184A is rotated, the thermoformed sheet of plastic 116 is laser marked at a second substation, the dial system 184A is again rotated, the thermoformed sheet of plastic 116 is unloaded (e.g., along with the molds, without the molds) from the plate 152, and the dial system 184A is again rotated (e.g., to locate the first group of two or more pallets 112 in the loading station 110).

In some embodiments, the dental appliance manufacturing system 100B includes multiple dial systems 184. A dial system 184B may be located under the dial system 184A. The dial system 184B may be used to locate the lifting device 156, plate 152, and/or one or more molds 154 under the corresponding pallet 112 securing a sheet of plastic 116 in the thermoforming station 130. The lifting device 156 may lift the plate 152 securing one or more molds 154 to the pallet 112 securing the sheet of plastic 116 to thermoform the sheet of plastic 116 on the one or more molds. The dial system 184B may rotate through one or more different stations. In some embodiments, a plate 152 may be loaded to the dial system 184B at a station of the dial system 184B. In some embodiments, one or more molds 154 may be loaded on a plate 152 at a station of the dial system 184B. In some embodiments, the one or more molds 154 and/or the plate 152 are unloaded from the dial system 184B at a station of the dial system 184B. In some embodiments, the lifting device 156 remains located under the thermoforming station 130 and the lifting device 156 lifts the plate 152 securing the molds 154 from the dial system 184B to the pallet 112 securing the sheet of plastic 116. In some embodiments, the lifting device 156 rotates with the dial system 184B.

In some embodiments, the dial system 184A and the dial system 184B rotate in the same direction (e.g., both clockwise, both counter-clockwise). In some embodiments, the dial system 184A and the dial system 184B rotate in opposite directions. In some embodiments, the dial system 184A and the dial system 184B rotate simultaneously or substantially simultaneously (e.g., at the same speed, etc.). In some embodiments, the dial system 184A and the dial system 184B are rotated separately (e.g., the pallet 112 securing a sheet of plastic 116 may be rotated to the thermoforming station 130 at a time different than the plate 152 securing the one or more molds 154 is rotated under the thermoforming station 130).

In some embodiments, the dial system 184A may include multiple groups of two or more pallets 112. A first group may be located in the loading station 110, a second station may be located at the heating station 120, a third group may be located in the thermoforming station 130, and a fourth group may be located in the one or more processing stations 140. In some embodiments, different stations of the dial system 184A are being interacted with at substantially the same time. In some embodiments, a sheet of plastic 116A is being placed on a pallet 112A, a heater 122 is heating the sheet of plastic 116B loaded on a pallet 112B, and a pressure device 132 is thermoforming a heated sheet of plastic 116C secured to a pallet 112C at substantially the same time. In some embodiments, different stations of the dial system 184B are being interacted with at substantially the same time.

In some embodiments, width and/or length of the pallets 112 of dial system 184A are adjustable based on the molds 154 to be used for thermoforming. In some embodiments, the heater 122, mask 124, pressure device 132, plate 152, lifting device 156, and/or the like are configurable based on the molds 154 to be used for thermoforming.

The operations of forming a dental appliance by using a conveyor system 170 may be applied to forming a product (e.g., mold 154, dental appliance 144) by using one or more dial systems 184A-B.

FIGS. 2A-B illustrate end effector tools 162, according to certain embodiments. In some embodiments, FIG. 2A illustrates end effector tool 162 disposed above a product 230 (e.g., mold 154, dental appliance 144, dental product, etc.) and FIG. 2B illustrates the end effector tool 162 disposed on the product 230 (e.g., fluid covering the product 230 with a membrane 246 disposed between the fluid 216 and product 230).

In some embodiments, end effector tool 162 includes a fluid containing portion 210 (e.g., cup) that includes a distal wall 212 (e.g., upper wall) located at a first distal end of the fluid containing portion 210 and one or more sidewalls 214 extending from the distal wall 212. The distal wall 212 and the one or more sidewalls 214 partially enclose an interior volume 218 of the end effector tool 162. A fluid 216 is disposed in the interior volume 218 of the fluid containing portion 210.

The end effector tool 162 further includes an actuator 220 configured to apply energy to the fluid 216 to change the fluid 216 between a liquid state and a solid state. The fluid containing portion 210 is to be placed over a product 230 (e.g., a mold 154 or a dental appliance 144) to cover the product 230 with the fluid 216 in the liquid state. The fluid 216 is to secure the product 230 responsive to the fluid 216 being changed from the liquid state to the solid state.

In some embodiments, the end effector tool 162 further includes a membrane 246 (e.g., thin film membrane, bio-compatible material) secured to the one or more sidewalls 214 at a second distal end of the fluid containing portion 210. In some embodiments, the membrane 246 surrounds the fluid 216 (e.g., membrane 246 is secured to sidewalls 214 and/or distal wall 212). In some embodiments, the membrane is at the second distal end of the fluid containing portion 210 without surrounding the fluid 216. The membrane 246, the distal wall 212, and the one or more sidewalls 214 enclose the interior volume 218 of the end effector tool 162. The membrane 246 is configured to deform around the product 230 to cause the fluid 216 to cover the product 230. In some embodiments, the membrane has a rough surface to increase the friction between the membrane and the product. In some embodiments, the membrane has a smooth surface.

In some embodiments, the fluid 216 is a non-Newtonian fluid and the actuator 220 is a mechanical vibration device configured to apply mechanical energy to the fluid 216 (e.g., configured to agitate the fluid 216) to cause the fluid 216 to be in the solid state. In some embodiments, the fluid 216 (e.g., non-Newtonian fluid) includes one or more of a rheopectic material, Bingham plastic material, thixotropic material, or pseudo plastic material. The fluid 216 may have a high shear stress with low strain rate.

In some embodiments, the fluid 216 includes a thermosensitive hydrogel and the actuator 220 includes a temperature adjustment device configured to adjust temperature of the fluid 216 to cause the fluid 216 to be in the solid state. The fluid 216 may be in a liquid state at less than about 15 degrees Celsius and may be in a solid state at about room temperature. In some embodiments, the fluid 216 (e.g., thermosensitive hydrogel) is Pluronic. Pluronic may be a poloxamer. Pluronic may be a triblock copolymer F127 [(poly(ethylene oxide))106-(poly(propylene oxide))70-(poly(ethylene oxide))106]. Pluronic may be a Pluronic F127.

In some embodiments, the actuators 220 (e.g., mechanical vibration devices) are disposed at the first distal end of the fluid containing portion 210 (e.g., are coupled to the distal wall 212).

In some embodiments, the actuators 220 (e.g., temperature adjusting devices) are coupled to one or more sidewalls 214. In some embodiments, the actuators 220 (e.g., temperature adjusting devices) are thermo-electric coolers. In some embodiments, the thermo-electric coolers in a cold condition cause the fluid 216 to be in a liquid state (e.g., film membrane deforms around product 230) and the thermos-electric cooler in a hot condition cause the fluid 216 to be in a gel state (e.g., substantially solid state).

In some embodiments, the fluid containing portion 210 is a cup and the end effector tool 162 further includes a shaft 240 secured to the distal wall 212 of the cup to adjust location of the cup to move the product 230.

In some embodiments, the product 230 includes the dental appliance 144 that includes one or more of an aligner, retainer, palatal expander, or prefabricated template. In some embodiments, the product 230 includes the mold 154.

In some embodiments, the end effector tool 162 forms one or more reservoirs 242 (e.g., reservoirs for fluid displacement) configured to receive a portion of the fluid 216 that has been displaced responsive to covering the product 230 with the fluid 216 in the liquid state.

In some embodiments, the end effector tool 162 is configured to provide a vacuum pressure (e.g., via vacuum device 244) to secure the fluid 216 in the liquid state in the interior volume 218 of the end effector tool 162 (e.g., vacuum to hold the liquid in place when in fluid state). In some embodiments, the end effector tool 162 may have a vacuum device 244 without a membrane 246. The vacuum device 244 may hold the fluid 216 in place in the fluid containing portion 210 when the fluid 216 is in liquid state. In some embodiments, the membrane 246 completely surrounds the fluid to prevent the fluid from going into the vacuum device 244 and filling the vacuum device 244. In some embodiments, a first membrane 246 is disposed below the fluid 216 (e.g., between fluid 216 and the product 230) and a second membrane is disposed above the fluid 216 (e.g., between fluid 216 and vacuum device 244).

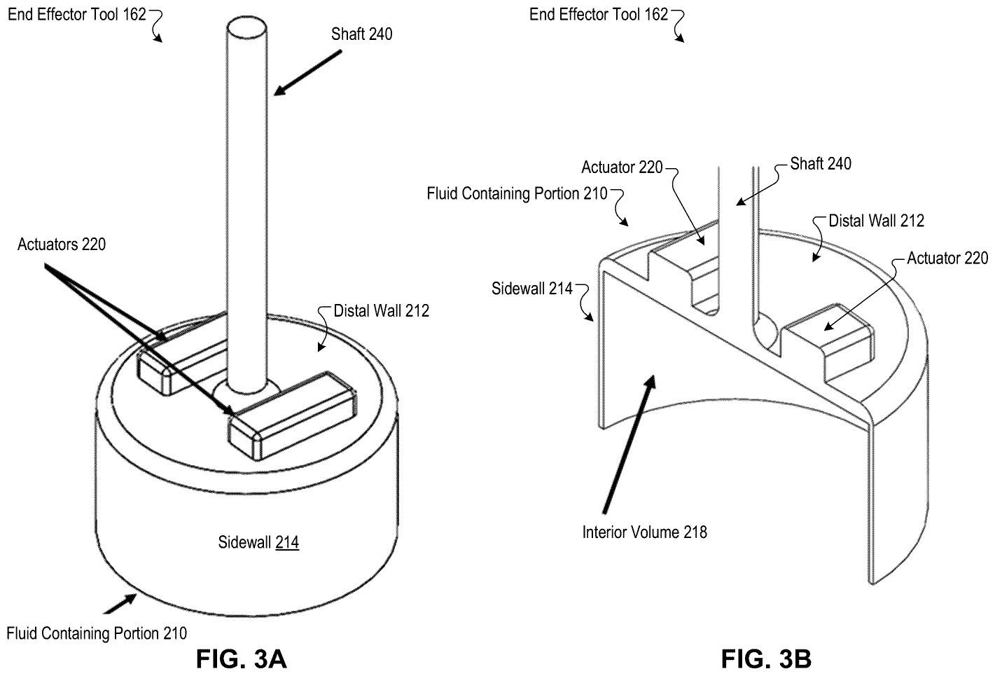

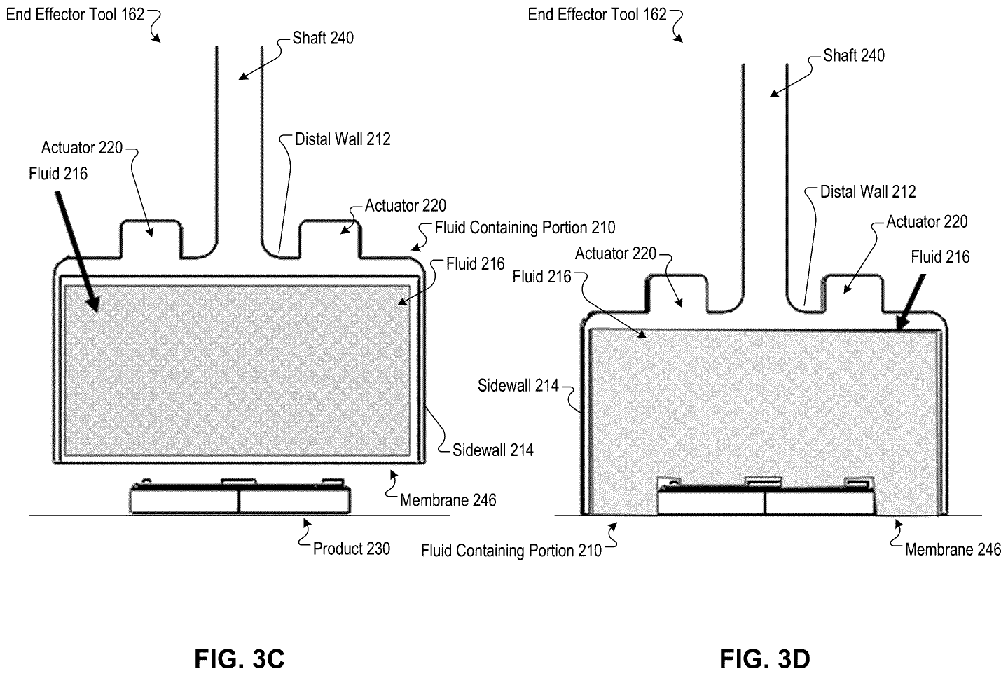

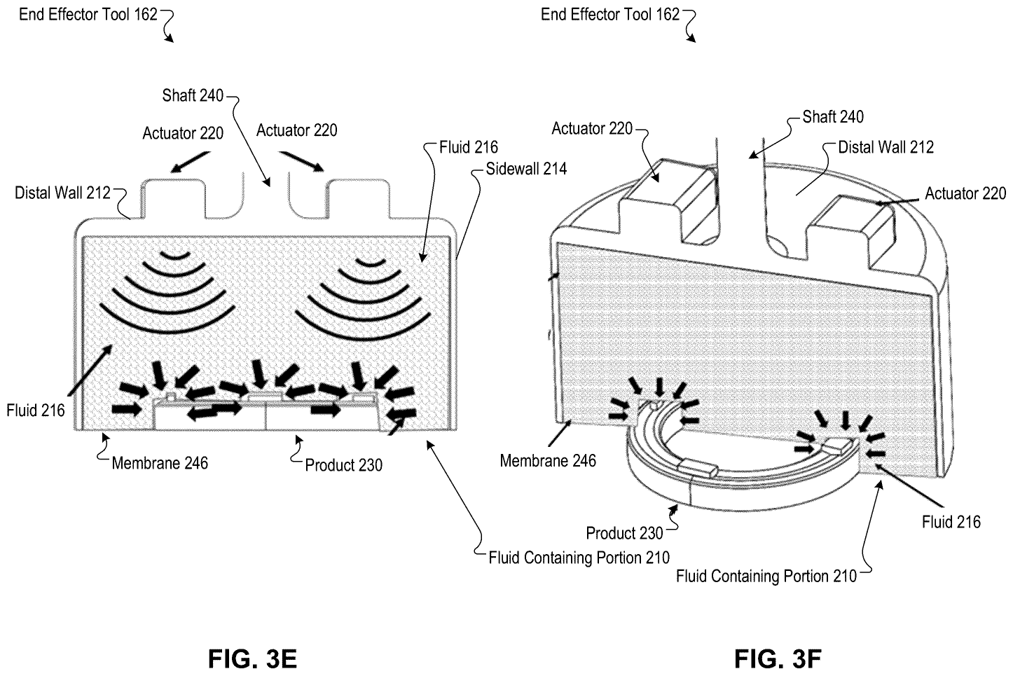

FIGS. 3A-F illustrate end effector tools 162, according to certain embodiments.

FIG. 3A illustrates a perspective view of an end effector tool 162 and FIG. 3B illustrates a cut-away perspective view of an end effector tool 162, according to certain embodiments. In some embodiments, the end effector tool 162 (e.g., morphing end effector tool) includes a shaft 240 coupled (e.g., attached) to a distal wall 212 of a fluid containing portion 210 (e.g., non-Newtonian fluid cup). One or more actuators 220 (e.g., mechanical vibration devices) are coupled to the fluid containing portion 210 (e.g., coupled to the distal wall 212). The fluid containing portion 210 forms an interior volume 218 (e.g., space for non-Newtonian fluid, non-Newtonian fluid cavity).

FIG. 3C illustrates a cross-sectional front view of an end effector tool 162 disposed above a product 230 (e.g., dental product, mold, appliance) and FIG. 3D illustrates a cross-sectional front view of the end effector tool 162 disposed on the product 230, according to certain embodiments. FIGS. 3C-D may illustrate the fluid (e.g., non-Newtonian fluid) in a liquid state. The actuators 220 (e.g., mechanical vibration devices) may not be applying energy (e.g., mechanical energy) to the fluid.

The pick and place of the product 230 (e.g., mold) using the end effector 162 (e.g., morphing end effector tool) may begin with the placement of the fluid containing portion 210 over the product 230 (e.g., mold) to be moved as shown in FIG. 3C. At this point, the fluid (e.g., non-Newtonian fluid) may be in a liquid state and the actuators 220 (e.g., mechanical vibration devices) may not be applying energy (e.g., mechanical energy to the fluid 216. Once the fluid containing portion 210 (e.g., cup) is over the product 230 (e.g., mold), the fluid containing portion 210 descends to cover the product 230 with the fluid 216 (e.g., non-Newtonian fluid) that is still in liquid state as shown in FIG. 3D. The fluid 216 (e.g., non-Newtonian fluid) may cover the entire product 230.

FIG. 3E illustrates a cross-sectional front view of an end effector tool 162 disposed on a product 230 and FIG. 3F illustrates a cut-away perspective view of the end effector tool 162 disposed on the product 230, according to certain embodiments. FIGS. 3E-F illustrate actuators 220 applying energy to the fluid 216 to cause the fluid 216 to change its state to secure the product 230.

Once the product 230 is completely covered by the fluid 216 and/or the membrane 246 (e.g., non-Newtonian fluid membrane), the actuators 220 (e.g., mechanical vibration devices) start to apply energy (e.g., mechanical energy) to the fluid 216 to change the material state of the fluid 216 to a solid state, resulting in fluid force clamping the product 230 (e.g., mold) inside the fluid containing portion 210 (e.g., cup) as shown in FIGS. 3E-F. Finally, to release the mold from the fluid 216 (e.g., the non-Newtonian fluid system), the actuators 220 (e.g., mechanical vibration devices) may cease to apply energy (e.g., mechanical energy) to the fluid 216 to release the product 230 to the final position.

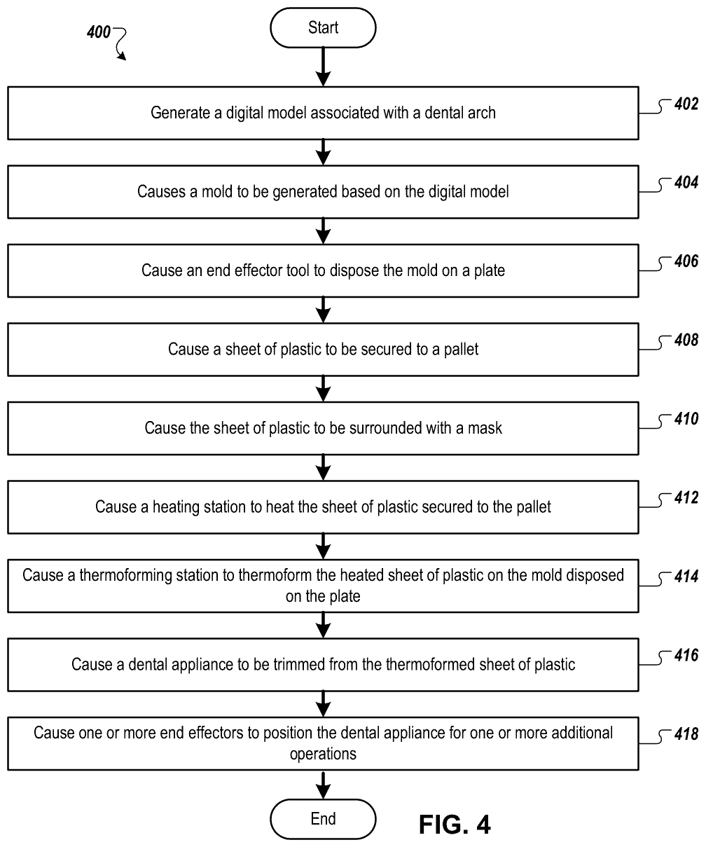

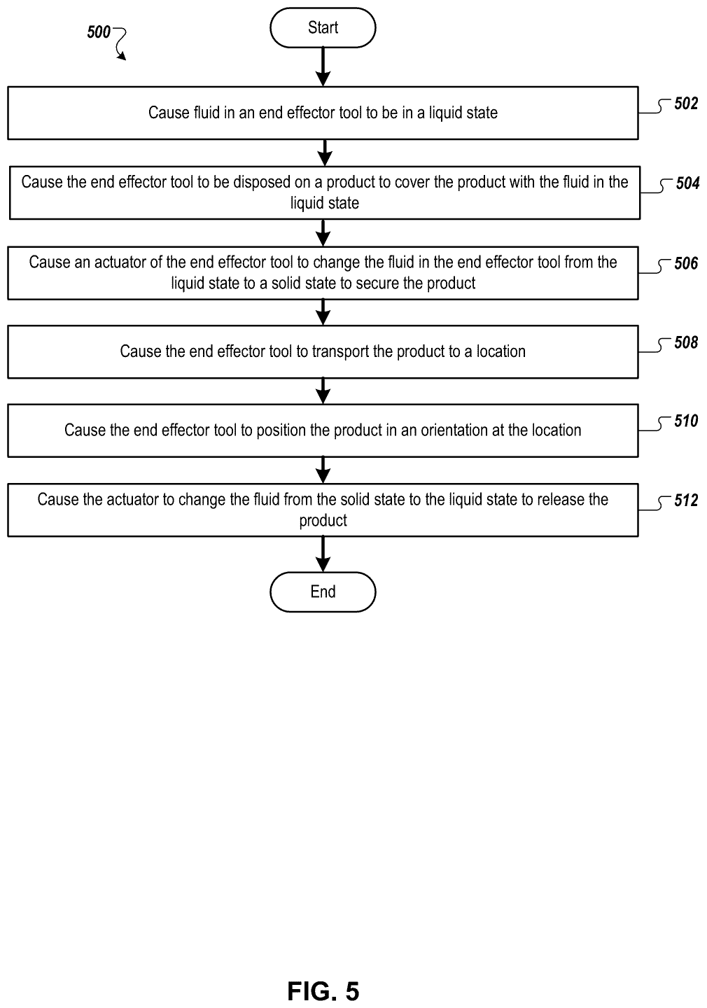

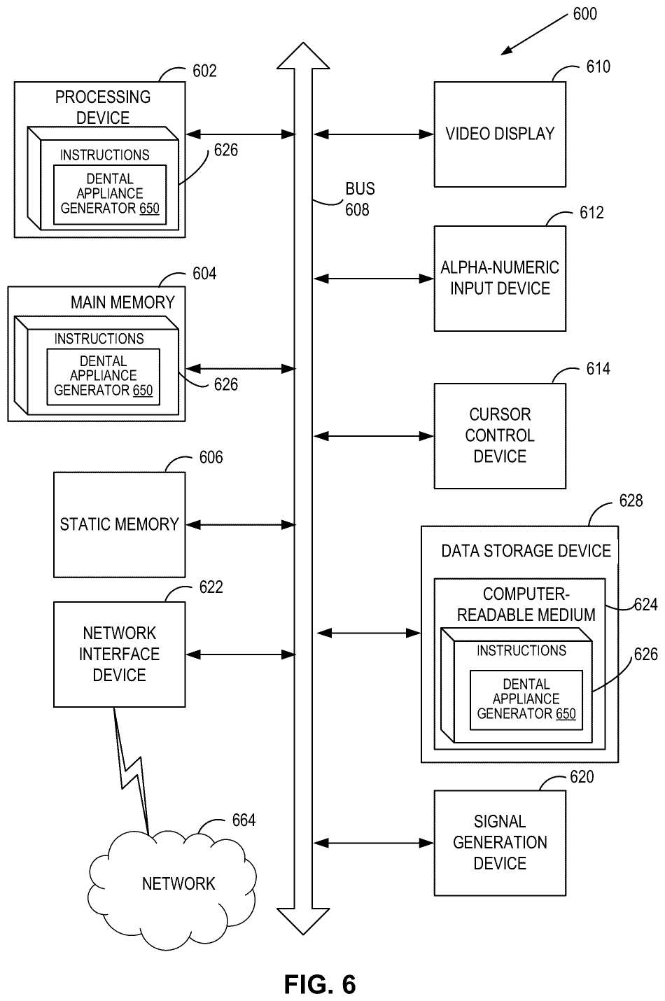

FIGS. 4-5 illustrate flow diagrams for methods 400 and 500 associated with dental appliances, according to certain embodiments. In some embodiments, one or more operations of methods 400 and 500 are performed by a processing logic of a computing device (e.g., controller 190) to automate one or more operations of forming a dental appliance. The processing logic may include hardware (e.g., circuitry, dedicated logic, programmable logic, microcode, etc.), software (e.g., instructions executed by a processing device), firmware, or a combination thereof. For example, one or more operations of methods 400 and 500 may be performed by a processing device executing a program or module, such as dental appliance generator 650 of FIG. 6.

Conventionally, mechanical grippers are used for mold and/or dental appliance manipulation between processes to manufacture dental appliances (e.g., using 3D printers and thermoforming processes, via direct fabrication, etc.). Conventionally, the mechanical gripper picks the product (e.g., mold or dental appliance) on a set of two or more specific, geometrically set points for manipulation. This may cause waste of material and operations and may have increased error.

In some embodiments, an end effector tool (e.g., end effector tool 162 of one or more of FIGS. 1A-3F, morphing end effector tool) generates a homogenous picking surface by using a fluid (e.g., non-Newtonian fluid) that fully covers the product (e.g., mold, dental appliance, mold/dental appliance set) and by the application of energy (e.g., high-frequency mechanical waves), the fluid may behave as a solid substance, holding the product (e.g., mold, dental appliance, mold/dental appliance set) during the material handling between processes.

The present disclosure may remove the pre-determined picking location points (e.g., protrusions, substantially flat areas, etc.) for dental appliances.

In some embodiments, the end effector tool (e.g., end effector tool 162 of one or more of FIGS. 1A-3F, morphing end effector tool) uses thermosensitive hydrogels that undergo sol-gel transition with temperature stimulus. The sol-gel transition allows one or more products (e.g., one or more molds and/or one or more dental appliances) to be immersed in the hydrogel in the liquid state and allows the one or more products to be picked up when the liquid transitions to the gel state under temperature stimulus.

Conventionally, handling process for products (e.g., dental appliances, molds, aligners, etc.) is performed by a pick and place process in which the product is held via a geometrically defined constant feature of the product (e.g., protrusion). Conventionally, high precision and complex manipulation is to be used to safely (e.g., avoiding any potential damage to the product), move the product across the manufacturing process. The end effector tool of the present disclosure may adapt shape to different products (e.g., every dental mold, etc.) to allow increased picking range.

The present disclosure may reduce complexity in material handling and may increase holding area to reduce stress in current picking location. Since morphing end effector tooling will hold the product (e.g., mold) from other surfaces, the conventional picking feature (e.g., protrusion) on the product (e.g., mold) can be removed, resulting in less use of material (e.g., less resin during printing).

Referring to FIG. 4, at block 402 of method 400, processing logic generates a digital model associated with a dental arch. A shape of a dental arch for a patient at a treatment stage may be determined based on a treatment plan to generate the digital model of the mold. In the example of orthodontics, the treatment plan may be generated based on an intraoral scan of a dental arch to be modeled. The intraoral scan of a patient's dental arch may be performed to generate a three dimensional (3D) virtual model of the patient's dental arch. For example, a full scan of the mandibular and/or maxillary arches of a patient may be performed to generate 3D virtual models thereof. The intraoral scan may be performed by creating multiple overlapping intraoral images from different scanning stations and then stitching together the intraoral images to provide a composite 3D virtual model. In other applications, virtual 3D models may also be generated based on scans of an object to be modeled or based on use of computer aided drafting techniques (e.g., to design the virtual 3D mold). Alternatively, an initial negative mold may be generated from an actual object to be modeled. The negative mold may then be scanned to determine a shape of a positive mold that will be produced.

Once the virtual 3D model of the patient's dental arch is generated, a dental practitioner may determine a desired treatment outcome, which includes final positions and orientations for the patient's teeth. Processing logic may then determine a number of treatment stages to cause the teeth to progress from starting positions and orientations to the target final positions and orientations. The shape of the final virtual 3D model and each intermediate virtual 3D model may be determined by computing the progression of tooth movement throughout orthodontic treatment from initial tooth placement and orientation to final corrected tooth placement and orientation. For each treatment stage, a separate virtual 3D model of the patient's dental arch at that treatment stage may be generated. The shape of each virtual 3D model will be different. The original virtual 3D model, the final virtual 3D model and each intermediate virtual 3D model is unique and customized to the patient.

The processing logic may determine an initial shape for a mold of the patient's dental arch at a treatment stage based on the digital model of the dental arch at that treatment stage. Processing logic may additionally determine one or more features to add to the mold that will cause the dental appliance formed over the mold to have the determined markings and/or elements.

The processing logic may determine a final shape for the mold and may generate a digital model of the mold. Alternatively, the digital model may have already been generated. In such an instance, processing logic updates the already generated digital model to include the determined features for the mold. The digital model may be represented in a file such as a computer aided drafting (CAD) file or a 3D printable file such as a stereolithography (STL) file. The digital model may include instructions that will control a fabrication system or device in order to produce the mold with specified geometries.

At block 404, processing logic causes a mold to be generated based on the digital mold. A virtual 3D model of a patient's dental arch may be used to generate a unique customized mold of the dental arch at a particular stage of treatment. The shape of the mold may be at least in part based on the shape of the virtual 3D model for that treatment stage. The mold may correspond to a dental arch of a patient and the mold may include a sloping portion that commences below a gum line of the dental arch and extends away from the dental arch to a lower portion of the mold. A portion of the thermoformed sheet of plastic that is disposed on the sloping portion of the mold is to be trimmed (e.g., to trim the dental appliances from the thermoformed sheet of plastic). In some embodiments, at block 404, the mold is generated with the sloping portion commencing below the gum line to assist in the release of the thermoformed sheet of plastic from the mold. The mold may be formed using a rapid prototyping equipment (e.g., 3D printers) to manufacture the mold using additive manufacturing techniques (e.g., stereolithography) or subtractive manufacturing techniques (e.g., milling). The digital model may be input into a rapid prototyping machine. The rapid prototyping machine then manufactures the mold using the digital model. One example of a rapid prototyping manufacturing machine is a 3D printer. 3D Printing includes any layer-based additive manufacturing processes. 3D printing may be achieved using an additive process, where successive layers of material are formed in proscribed shapes. 3D printing may be performed using extrusion deposition, granular materials binding, lamination, photopolymerization, continuous liquid interface production (CLIP), or other techniques. 3D printing may also be achieved using a subtractive process, such as milling.

In one embodiment, stereolithography (SLA), also known as optical fabrication solid imaging, is used to fabricate an SLA mold. In SLA, the mold is fabricated by successively printing thin layers of a photo-curable material (e.g., a polymeric resin) on top of one another. A platform rests in a bath of a liquid photopolymer or resin just below a surface of the bath. A light source (e.g., an ultraviolet laser) traces a pattern over the platform, curing the photopolymer where the light source is directed, to form a first layer of the mold. The platform is lowered incrementally, and the light source traces a new pattern over the platform to form another layer of the mold at each increment. This process repeats until the mold is completely fabricated. Once all of the layers of the mold are formed, the mold may be cleaned and cured.

Materials such as a polyester, a co-polyester, a polycarbonate, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, or combinations thereof, may be used to directly form the mold. The materials used for fabrication of the mold can be provided in an uncured form (e.g., as a liquid, resin, powder, etc.) and can be cured (e.g., by photopolymerization, light curing, gas curing, laser curing, crosslinking, etc.). The properties of the material before curing may differ from the properties of the material after curing.

Optionally, the rapid prototyping techniques described herein allow for fabrication of a mold including multiple materials, referred to herein as “multi-material direct fabrication.” In some embodiments, a multi-material direct fabrication method involves concurrently forming an object from multiple materials in a single manufacturing step. For instance, a multi-tip extrusion apparatus can be used to selectively dispense multiple types of materials (e.g., resins, liquid, solids, or combinations thereof) from distinct material supply sources in order to fabricate an object from a plurality of different materials. Alternatively or in combination, a multi-material direct fabrication method can involve forming an object from multiple materials in a plurality of sequential manufacturing steps. For instance, a first portion of the object (e.g., a main portion of the mold) can be formed from a first material in accordance with any of the direct fabrication methods herein, then a second portion of the object (e.g., complex features added to the mold) can be formed from a second material in accordance with methods herein, and so on, until the entirety of the object has been formed. The relative arrangement of the first and second portions can be varied as desired. In one embodiment, multi-material direct fabrication is used to cause a first material to be used for the markings of the cut line on the mold, and to cause one or more additional materials to be used for the remainder of the mold.

Dental appliances may be formed from a mold to provide forces to move the patient's teeth. The shape of each dental appliance is unique and customized for a particular patient and a particular treatment stage. In an example, the dental appliances can be pressure formed or thermoformed over the molds. A mold may be used to fabricate a dental appliance that will apply forces to the patient's teeth at a particular stage of the orthodontic treatment. The dental appliances each have teeth-receiving cavities that receive and resiliently reposition the teeth in accordance with a particular treatment stage.

At block 406, processing logic causes an end effector tool (e.g., end effector tool 162 of one or more of FIGS. 1A-3F) to transport the mold to dispose the mold on a plate. The processing logic may use the end effector tool via method 500 of FIG. 5 to secure the mold, move the mold, and dispose the mold on the plate.

Processing logic may determine positioning of one or more molds on the plate. The positioning may include at least two degrees of freedom (e.g., x-direction positioning and y-direction positioning. The positioning may include at least three degrees of freedom (e.g., x-direction positioning, y-direction positioning, and/or rotational positioning). The positioning may be free-form positioning where only a minimum clearance is to be between content. The positioning may be U-shape where the plastic sheet is shut in a U shape (e.g., oval shape, two half oval shapes) and is utilized for the thermoforming process.

The one or more molds may be secured to the plate via fasteners such as a pin, a keyway, and a locking mechanism. The mold may be secured to the plate to avoid movement in the x-, y-, and z-direction and to avoid rotation (e.g., change in angle) of the molds.

At block 408, processing logic causes a sheet of plastic to be secured to a pallet. The sheet of plastic may be selected (e.g., length, width, and/or thickness of the sheet of plastic is selected) based on the one or more molds. The sheet of plastic may be an elastic thermoplastic, a sheet of polymeric material, etc. The sheet of plastic may be lowered onto the pallet so that holding pins of the pallet pierce the sheet of plastic to secure the sheet of plastic to the pallet. The sheet of plastic is secured to the pallet and the pallet securing the sheet of plastic is transferred to a heating station.

At block 410, processing logic causes the sheet of plastic to be surrounded with a mask. The mask may be sized based on the one or more molds on the plate. The length and/or width of the mask may be controlled by the heating station, by servo motors, by pneumatics, and/or the like. A pressurized cylinder of the heating station may lower the mask onto the sheet of plastic secured to the pallet.

At block 412, processing logic causes a heating station to heat the sheet of plastic secured to the pallet. The heating station may be configured based on the one or more molds disposed on the plate. One or more of heating element location, temperature, mask size, and/or the like of the heating station may be configured (e.g., based on the positioning of the one or more molds on the plate.) The sheet of plastic may be heated to a temperature at which the sheet of plastic becomes pliable. The sheet of plastic may be heated using a ceramic heater, convection oven, or infrared heater. The mask may allow the sheet of plastic to be heated to, for example, 336° F. without hanging to avoid air leaks. A mask may be placed on the sheet of plastic to minimize heat transfer from the heater to other sheets of plastic. The heated sheet may be transferred to a thermoforming station.

At block 414, processing logic causes a thermoforming station to thermoform the heated sheet of plastic on the mold disposed on the plate. The heated sheet of plastic may be simultaneously thermoformed to the one or more molds (e.g., that are secured to the plate) via a thermoforming station that is configured based on the one or more molds on the plate. One or more of the thermoforming cup dimensions (e.g., length, width, height) or pressure level may be configured (e.g., based on the positioning of the one or more molds on the plate). To thermoform the heated sheet of plastic over the one or more molds on the plate, pressure may concurrently be applied to the sheet of plastic to form the now pliable sheet of plastic around the one or more molds on the plate (e.g., with features that will imprint markings and/or elements in the dental appliances formed on the one or more molds). Once the sheet cools, the sheet has a shape that conforms to the one or more molds. In some embodiments, a release agent (e.g., a non-stick material) is applied to the one or more molds before forming the dental appliances (e.g., shells). This may facilitate later removal of the one or more molds from the shells. In some embodiments, the sheet of plastic is pressure formed over the one or more molds simultaneously. To unload the thermoformed sheet from the pallet and form the dental appliances, the thermoformed sheet may be transferred to an unloading station.

At block 416, processing logic causes a dental appliance to be trimmed from the thermoformed sheet of plastic. The thermoformed sheet of plastic may be removed from the one or more molds (e.g., using a shell removal device). The thermoformed sheet of plastic may be trimmed to generate one or more dental appliances. In some embodiments, for each mold, the portion of thermoformed sheet of plastic that is disposed on a portion of the corresponding mold that slopes outward below the gum line is removed during the trimming of the thermoformed sheet of plastic to generate the dental appliances. After the thermoformed sheet of plastic is removed from the mold for a treatment stage, the thermoformed sheet of plastic is subsequently trimmed along one or more cut lines (also referred to as a trim line). The cut line may be a gingival cut line that represents an interface between a dental appliance and a patient's gingiva. In one embodiment, the dental appliance is manually cut by a technician using scissors, a bur, a cutting wheel, a scalpel, or any other cutting implement. In another embodiment, the dental appliance is cut by a computer controlled trimming machine such as a CNC machine or a laser trimming machine. The computer controlled trimming machine may control an angle and position of a cutting tool of the trimming machine to trim the thermoformed sheet of plastic. In some embodiments, the thermoformed sheet of plastic is divided into two parts (each part corresponding to a respective dental appliance) prior to the trimming of thermoformed sheet of plastic to generate the dental appliances.

At block 418, processing logic causes one or more end effectors to position the dental appliance for one or more additional operations. The processing logic may use the end effector tool via method 500 of FIG. 5 to secure the dental appliance, move the dental appliance, position the dental appliance, and release the dental appliance. The one or more additional operations may include one or more of a laser trimming operation, a laser marking operation, a laser operation, a laser smoothing operation, and/or the like.

In some embodiments, the transferring of the pallet securing the sheet of plastic is via a conveyor system (e.g., via lateral movement, via conveyor system 170 of FIG. 1A). In some embodiments, the transferring of the pallet securing the sheet of plastic is via a dial system (e.g., via rotational movement, via dial system 184A of FIG. 1B).

In some embodiments, the one or more molds are transferred to be located below the thermoforming station and are lifted to have the heated sheet thermoformed over the one or more molds. In some embodiments, the transferring of the one or more molds to be located below the thermoforming station is via lateral movement. In some embodiments, the transferring of the first mold and the second mold to be located below the thermoforming station is via rotational movement (e.g., via dial system 184A of FIG. 1B).

Referring to FIG. 5, at block 502 of method 500, processing logic causes fluid in an end effector tool to be in a liquid state (e.g., non-Newtonian fluid is in liquid state). The end effector tool may be the end effector tool 162 of one or more of FIGS. 1A-3F. The fluid may be one or more of a non-Newtonian fluid, a thermosensitive hydrogel, etc. The fluid may be changed between liquid state and solid state via application of energy. In some embodiments, at block 502, energy is applied (e.g., via one or more actuators) to cause the fluid to be in the liquid state. In some embodiments, at block 502, energy prevented from being applied (e.g., via one or more actuators) to cause the fluid to be in the liquid state. The one or more actuators may include one or more of a mechanical vibration device, a temperature adjustment device, a gas supply device, etc. that cause the fluid to be changed between liquid state and solid state.

The end effector tool (e.g., morphing end effector system) may include a shaft, an actuator (e.g., mechanical vibration devices), and a fluid containing portion (e.g., the non-Newtonian fluid cup) forming an interior volume (e.g., inner cup space). The interior volume may be filled with a non-Newtonian fluid (e.g., contained in a sealed membrane).

In some embodiments, processing logic causes vacuum pressure to be provided to secure the fluid in the liquid state in the end effector tool. In some embodiments, a membrane causes the fluid in the liquid state to be secured in the end effector tool.

At block 504, processing logic causes the end effector tool to be disposed on a product (e.g., mold, dental appliance, etc.) to cover the product with the fluid in the liquid state. The processing logic may cause a fluid containing portion (e.g., cup holding non-Newtonian fluid in liquid state) of the end effector tool to be placed over the product (e.g., including a mold or a dental appliance) to cause the fluid in the liquid state (e.g., disposed in the fluid containing portion) to cover the product (e.g., product is completely or partially covered with the non-Newtonian fluid).

In some embodiments, the pick and place of a product (e.g., mold, dental appliance) using the end effector tool (e.g., morphing end effector system) may include placement of the fluid containing portion (e.g., cup) over the product (e.g., mold) to be moved. At this point, the fluid (e.g., non-Newtonian fluid) is in liquid state and the actuators (e.g., mechanical vibration devices) may not be applying energy (e.g., mechanical energy) to the fluid. Once the fluid containing portion (e.g., cup) is over the product (e.g., mold), the fluid containing portion descends to cover the product (e.g., mold) with the fluid (e.g., non-Newtonian fluid) that is still in liquid state.

At block 506, processing logic causes an actuator of the end effector tool to change the fluid in the end effector tool from the liquid state to a solid state to secure the product. In some embodiments, the fluid in the liquid state is malleable to form over the product (e.g., without securing the object) and the fluid in the solid state is firm enough to secure the product during movement. In some embodiments, liquid state is not completely liquid and/or solid state is not completely solid. In some embodiments, the fluid in the liquid state conforms to the shape of the product when placed on the product and does not secure the product when lifted off of the product. The fluid in the solid state (e.g., that was placed on the product while the fluid was in the liquid state and changed from the liquid state to the solid state) may secure the product when lifted from the surface on which the product was disposed.

In some embodiments, once the product (e.g., mold, upper surface of the product, upper and side surfaces of the product) is fully covered by the fluid (e.g., covered by the non-Newtonian fluid membrane), the actuators (e.g., mechanical vibration devices) start to apply energy (e.g., mechanical energy) to the fluid, changing the material state of the fluid to a solid state, resulting in fluid force clamping the product (e.g., mold) inside the fluid containing portion (e.g., cup).

In some embodiments, the fluid includes (e.g., is) a non-Newtonian fluid that is configured to change between the liquid state and the solid state. The actuator may include a mechanical vibration device that is configured to apply mechanical energy to the fluid (e.g., non-Newtonian fluid) to change the fluid between the liquid state and the solid state. In some embodiments, a mechanical vibration device begins to apply mechanical energy to the non-Newtonian fluid to change the non-Newtonian fluid to a solid state to clamp the product (e.g., mold, dental appliance) inside the cup (e.g., to pick the product).

In some embodiments, the fluid includes (e.g., is) a thermosensitive hydrogel that is configured to change between the liquid state and the solid state. The actuator may include a temperature adjustment device that is configured to change temperature of the fluid (e.g., thermosensitive hydrogel to change the fluid between the liquid state and the solid state.

In some embodiments, the processing logic causes the actuator to provide more or less energy (e.g., cause the fluid to be in more of a solid state or less of a solid state) based on sensor data and/or properties of the product (e.g., size, weight, dimensions, roughness of surface of the product, and the like). In some examples, the processing logic may cause the actuator to provide more energy based on size of the product exceeding a threshold size. In some examples, the processing logic may cause the actuator to provide more energy based on a quantity of products to be secured exceeding a threshold quantity. In some examples, the processing logic may cause the actuator to adjust the energy based on shape, weight and/or roughness of the surface of the product.

At block 508, processing logic causes the end effector tool to transport the product to a location. This may be responsive to the causing of the actuator to change the fluid to the solid state and prior to the causing of the actuator to change the fluid to the liquid state. The end effector tool may travel from an initial position with the product and may reach a final position.

At block 510, processing logic causes the end effector tool to position the product in an orientation at the location.

In some embodiments, processing logic determines, based on sensor data, whether the product is one or more of in a correct orientation, in a correct location, secured by the end effector tool, etc. The sensor data may be one or more of laser data, sonar data, capacitance data, imaging data, etc. One or more sensors may provide the sensor data. In some embodiments, at least one of the one or more sensors may be coupled to the end effector tool. In some embodiments, at least one of the one or more sensors may be located proximate the initial location (e.g., pick up location). In some embodiments, at least one of the one or more sensors may be located proximate the final location (e.g., drop off location, plate). In some embodiments, at least one of the one or more sensors may be located at an intermediate location (e.g., between the initial location and the final location). In some embodiments, the processing logic determines, based on the sensor data, whether a corrective action is to be performed. For example, the processing logic may determine, based on the sensor data that the product dropped from the end effector tool and the processing logic may provide an alert and/or may pick up the fallen product. In another example, the processing logic may determine, based on the sensor data that the product is not firmly gripped by the end effector tool and may be dropped. The processing logic may increase the mechanical energy applied to the fluid (in the solid state) to increase firmness of the solid state and increase the gripping force applied to the product.

At block 512, processing logic causes the actuator to change the fluid from the solid state to the liquid state to release the product. In some embodiments, to release the product (e.g., mold) from the fluid (e.g., non-Newtonian fluid system), the actuators (e.g., mechanical vibration devices) cease to apply energy (e.g., mechanical energy) to the fluid, then, the product (e.g., mold) is released to a final position. In some embodiments, the mechanical vibration device ceases to apply mechanical energy to the fluid to release the product from the fluid and place the product in the final position.

FIG. 6 illustrates a diagrammatic representation of a machine in the example form of a computing device 600 within which a set of instructions, for causing the machine to perform any one or more of the methods described herein. In alternative embodiments, the machine may be connected (e.g., networked) to other machines in a Local Area Network (LAN), an intranet, an extranet, or the Internet. For example, the machine may be networked to a rapid prototyping apparatus such as a 3D printer or SLA apparatus. The machine may operate in the capacity of a server or a client machine in a client-server network environment, or as a peer machine in a peer-to-peer (or distributed) network environment. The machine may be a personal computer (PC), a tablet computer, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The example computing device 600 includes a processing device 602, a main memory 604 (e.g., read-only memory (ROM), flash memory, dynamic random access memory (DRAM) such as synchronous DRAM (SDRAM), etc.), a static memory 606 (e.g., flash memory, static random access memory (SRAM), etc.), and a secondary memory (e.g., a data storage device 628), which communicate with each other via a bus 608.

Processing device 602 represents one or more general-purpose processors such as a microprocessor, central processing unit, or the like. More particularly, the processing device 602 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processing device 602 may also be one or more special-purpose processing devices such as an application specific integrated circuit (ASIC), a field programmable gate array (FPGA), a digital signal processor (DSP), network processor, or the like. Processing device 602 is configured to execute the processing logic (instructions 626) for performing operations and steps discussed herein.

The computing device 600 may further include a network interface device 622 for communicating with a network 664. The computing device 600 also may include a video display unit 610 (e.g., a liquid crystal display (LCD) or a cathode ray tube (CRT)), an alphanumeric input device 612 (e.g., a keyboard), a cursor control device 614 (e.g., a mouse), and a signal generation device 620 (e.g., a speaker).

The data storage device 628 may include a machine-readable storage medium (or more specifically a non-transitory computer-readable storage medium) 624 on which is stored one or more sets of instructions 626 embodying any one or more of the methodologies or functions described herein. A non-transitory storage medium refers to a storage medium other than a carrier wave. The instructions 626 may also reside, completely or at least partially, within the main memory 604 and/or within the processing device 602 during execution thereof by the computing device 600, the main memory 604 and the processing device 602 also constituting computer-readable storage media.

The computer-readable storage medium 624 may also be used to store one or more instructions for dental appliance production and/or a dental appliance generator 650, which may perform one or more of the operations of methods described herein. The computer-readable storage medium 624 may also store a software library containing methods that call a dental appliance generator 650. While the computer-readable storage medium 624 is shown in an example embodiment to be a single medium, the term “non-transitory computer-readable storage medium” should be taken to include a single medium or multiple media (e.g., a centralized or distributed database, and/or associated caches and servers) that store the one or more sets of instructions. The term “non-transitory computer-readable storage medium” shall also be taken to include any medium that is capable of storing or encoding a set of instructions for execution by the machine and that cause the machine to perform any one or more of the methodologies of the present disclosure. The term “non-transitory computer-readable storage medium” shall accordingly be taken to include, but not be limited to, solid-state memories, and optical and magnetic media.

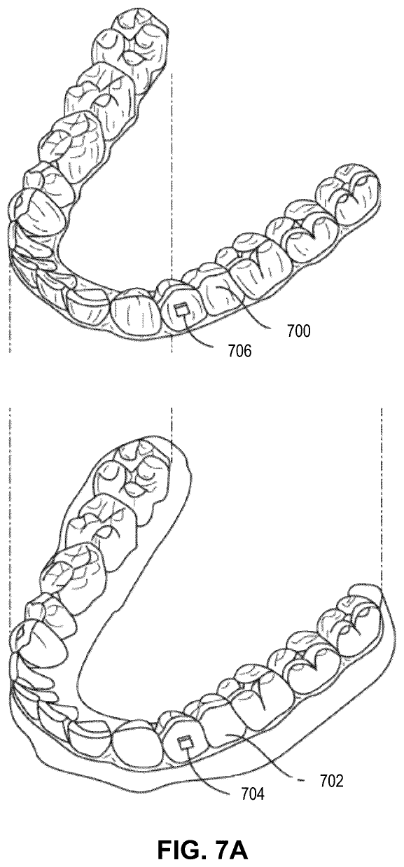

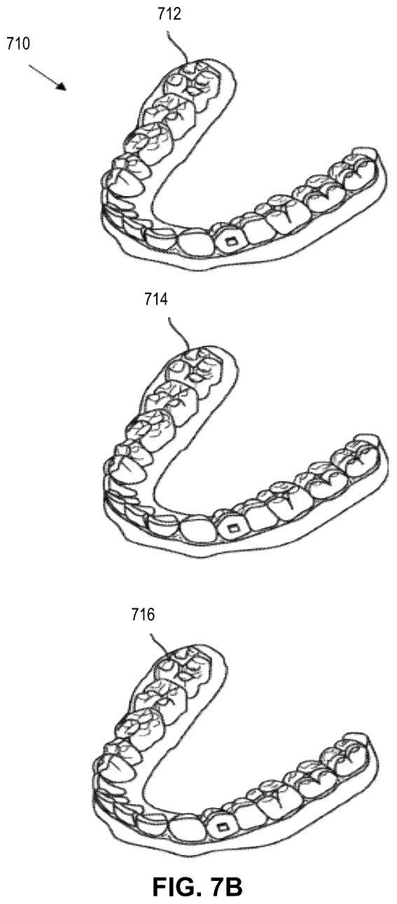

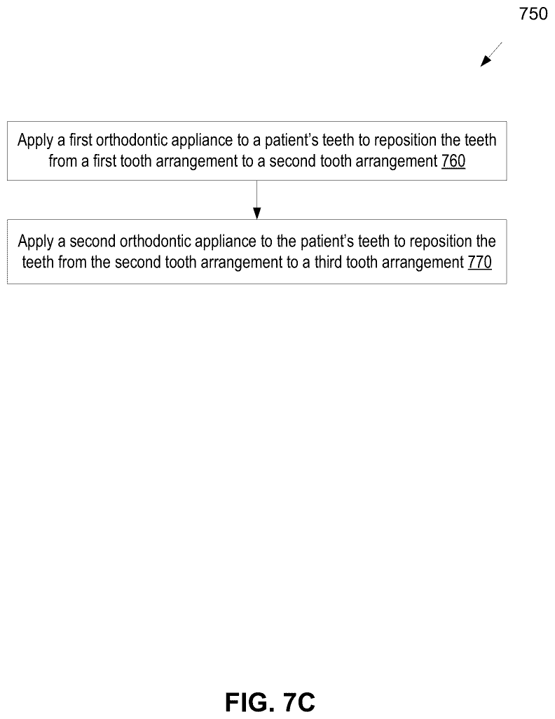

FIG. 7A illustrates an exemplary tooth repositioning appliance or aligner 700 that can be worn by a patient in order to achieve an incremental repositioning of individual teeth 702 in the jaw. An end effector tool 162 (e.g., of one or more of FIGS. 1A-5) may position the aligner 700 and/or the mold used to form the aligner for one or more operations, as described herein. The appliance can include a shell (e.g., a continuous polymeric shell or a segmented shell) having teeth-receiving cavities that receive and resiliently reposition the teeth. An appliance or portion(s) thereof may be indirectly fabricated using a physical model of teeth. For example, an appliance (e.g., polymeric appliance) can be formed using a physical model of teeth and a sheet of suitable layers of polymeric material. A “polymeric material,” as used herein, may include any material formed from a polymer. A “polymer,” as used herein, may refer to a molecule composed of repeating structural units connected by covalent chemical bonds often characterized by a substantial number of repeating units (e.g., equal to or greater than 3 repeating units, optionally, in some embodiments equal to or greater than 10 repeating units, in some embodiments greater or equal to 30 repeating units) and a high molecular weight (e.g. greater than or equal to 10,000 Da, in some embodiments greater than or equal to 50,000 Da or greater than or equal to 100,000 Da). Polymers are commonly the polymerization product of one or more monomer precursors. The term polymer includes homopolymers, or polymers consisting essentially of a single repeating monomer subunit. The term polymer also includes copolymers which are formed when two or more different types of monomers are linked in the same polymer. Useful polymers include organic polymers or inorganic polymers that may be in amorphous, semi-amorphous, crystalline, or semi-crystalline states. Polymers may include polyolefins, polyesters, polyacrylates, polymethacrylates, polystyrenes, Polypropylenes, polyethylenes, Polyethylene terephthalates, poly lactic acid, polyurethanes, epoxide polymers, polyethers, poly(vinyl chlorides), polysiloxanes, polycarbonates, polyamides, poly acrylonitriles, polybutadienes, poly(cycloolefins), and copolymers. The systems and/or methods provided herein are compatible with a range of plastics and/or polymers. Accordingly, this list is not all inclusive, but rather is exemplary. The plastics can be thermosets or thermoplastics. The plastic may be a thermoplastic.

Examples of materials applicable to the embodiments disclosed herein include, but are not limited to, those materials described in the following patent applications filed by Align Technology: “MULTILAYER DENTAL APPLIANCES AND RELATED METHODS AND SYSTEMS,” U.S. Pat. No. 9,655,691 to Li, et al., filed May 14, 2012; “SYSTEMS AND METHODS FOR VARYING ELASTIC MODULUS APPLIANCES,” U.S. Pat. No. 6,964,564 to Phan, et al., filed Jul. 26, 2002; “METHODS OF MAKING ORTHODONTIC APPLIANCES,” U.S. Pat. No. 7,641,828 to DeSimone, et al., filed Oct. 12, 2004; “TREATMENT OF TEETH BY ALIGNERS,” U.S. Pat. No. 8,740,614 to Wen et al., filed Jul. 29, 2009; and any applications claiming benefit therefrom or providing benefit thereto (including publications and issued patents), including any divisional, continuation, or continuation-in-part thereof, the content of which are incorporated by reference herein.

Examples of materials applicable to the embodiments disclosed herein include a hard polymer layer disposed between two soft polymer layers. In some embodiments, the hard inner polymer layer includes a co-polyester and has a polymer layer elastic modulus. In some embodiments, a first soft outer polymer layer and a second soft outer polymer layer each include a thermoplastic polyurethane elastomer and each have a soft polymer elastic modulus less than the hard polymer layer clastic modulus, a flexural modulus of greater than about 35,000 psi, a hardness of about 60A to about 85D, and a thickness in a range from 25 microns to 100 microns. In some embodiments, the hard inner polymer layer is disposed between the first soft outer polymer layer and the second soft outer polymer layer so as to reduce degradation of the resilient position force applied to the teeth when the appliance is worn. The hard polymer layer can include a polyester, a co-polyester, a polycarbonate, a thermoplastic polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate or a combination thereof (e.g., a blend of at least two of the listed hard polymeric materials). In some embodiments, the hard polymer layer includes two or more hard polymer layers. The soft outer polymer material may include a styrenic block copolymer (SBC), a silicone rubber, an elastomeric alloy, a thermoplastic elastomer (TPE), a thermoplastic vulcanizate (TPV) elastomer, a polyurethane elastomer, a block copolymer elastomer, a polyolefin blend elastomer, a thermoplastic co-polyester elastomer, a thermoplastic polyamide elastomer, or a combination thereof (e.g., a blend of at least two of the listed soft polymeric materials). The soft polymer layers can be the same material or a different material.

Examples of materials applicable to the embodiments disclosed herein include a middle layer disposed between two layers. The two layers individually include a thermoplastic polymer having a flexural modulus of from about 1,000 MPa to 2,500 MPa and a glass transition temperature and/or melting point of from about 80° C. to 180° C. The middle layer includes a polyurethane elastomer having a flexural modulus of from about 50 MPa to about 500 MPa and one or more of a glass transition temperature and/or melting point of from about 90° C. to about 220° C. The polymeric sheet composition has a combined thickness of the middle layer and the outer layers of from 250 microns to 2000 microns and a flexural modulus of from 500 MPa to 1,500 MPa. In some embodiments, the outer layers include one or more of a co-polyester, a polycarbonate, a polyester polycarbonate blend, a polyurethane, a polyamide, or a polyolefin. The middle layer may have a Shore hardness of from A90 to D55 and a compression set of less than 35% after 22 hours at 25° C. In some embodiments, the outer layers have a lateral restoring force of less than 100 Newtons (N) per square centimeter when displayed by 0.05 mm to 0.1 mm relative to each other. In some embodiments, the interplay peel strength between the outer layers and the middle layer is greater than 50 N per 2.5 cm. In some embodiments, the combined thickness of the outer layers is from 50 microns to 1,000 microns. In some embodiments one or more of the outer layers include a microcrystalline polyamide including from about 50 to 100 mole % of C6 to C14 aliphatic diacid moieties and about 50 to 100 mole % of 4,4′-methylene-bis(cyclohexylamine), having a glass transition of between about 100° C. and 180° C., a heat of fusion of less than 20 J/g and a light transmission of greater than 80%. In some embodiments, one or more of the outer layers includes a co-polyester including: a dicarboxylic acid component including 70 mole % to 100 mole % of terephthalic acid residues; and a diol component including (i) 0 to 90 mole % ethylene glycol, (ii) 5 mole % to 50 mole % of 2,2,4,4-tetramethyl-1,3-cyclobutanediol residues, (iii) 50 mole % to 95 mole % 1,4-cyclohexanedimethanol residues, and (iv) 0 to 1 mole % of a polyol having three or more hydroxyl groups, where the sum of the mole % of diol residues (i), (ii), (iii), and (iv) amounts to 100 mole % and the co-polyester exhibits a glass transition temperature Tg from 80° C. to 150° C. In some embodiments, the middle layer includes an aromatic polyether polyurethane having a Shore hardness of from A90 to D55 and a compression set of less than 35%, where the interlayer peel strength between the outer layers and the middle layer is greater than 50 N per 2.5 cm. In some embodiments, one or more of the outer layers includes a polyurethane that includes: a di-isocyanate including 80 mole % to 100 mole % of methylene diphenyl diisocyanate residues and/or hydrogenated methylene diphenyl diisocyanate; and a diol component including: (i) 0 to 100 mole % hexamethylene diol; and (ii) 0 to 50 mole % 1,4-cyclohexanedimethanol, where the sum of (i) and (ii) amounts to greater than 90 mole % and the polyurethane has a glass transition temperature Tg from about 85° C. to about 150° C.

Although polymeric aligners are discussed herein, the techniques disclosed may also be applied to aligners having different materials. Some embodiments are discussed herein with reference to orthodontic aligners (also referred to simply as aligners). However, embodiments also extend to other types of shells formed over molds, such as orthodontic retainers, orthodontic splints, sleep appliances for mouth insertion (e.g., for minimizing snoring, sleep apnea, etc.) and/or shells for non-dental applications. Accordingly, it should be understood that embodiments herein that refer to aligners also apply to other types of shells. For example, the principles, features and methods discussed may be applied to any application or process in which it is useful to perform simultaneous forming multiple shells which are any suitable type of shells that are form fitting devices such as eye glass frames, contact or glass lenses, hearing aids or plugs, artificial knee caps, prosthetic limbs and devices, orthopedic inserts, as well as protective equipment such as knee guards, athletic cups, or elbow, chin, and shin guards and other like athletic/protective devices.

The aligner 700 can fit over all teeth present in an upper or lower jaw, or less than all of the teeth. The appliance can be designed specifically to accommodate the teeth of the patient (e.g., the topography of the tooth-receiving cavities matches the topography of the patient's teeth), and may be fabricated based on positive or negative models of the patient's teeth generated by impression, scanning, and the like. Alternatively, the appliance can be a generic appliance configured to receive the teeth, but not necessarily shaped to match the topography of the patient's teeth. In some cases, only certain teeth received by an appliance will be repositioned by the appliance while other teeth can provide a base or anchor region for holding the appliance in place as it applies force against the tooth or teeth targeted for repositioning. In some cases, some, most, or even all of the teeth will be repositioned at some point during treatment. Teeth that are moved can also serve as a base or anchor for holding the appliance as it is worn by the patient. Typically, no wires or other means will be provided for holding an appliance in place over the teeth. In some cases, however, it may be desirable or necessary to provide individual attachments or other anchoring elements 704 on teeth 702 with corresponding receptacles or apertures 706 in the aligner 700 (e.g., appliance) so that the appliance can apply a selected force on the tooth. Exemplary appliances, including those utilized in the Invisalign® System, are described in numerous patents and patent applications assigned to Align Technology, Inc. including, for example, in U.S. Pat. Nos. 6,450,807, and 5,975,893, as well as on the company's website, which is accessible on the World Wide Web (see, e.g., the url “invisalign.com”). Examples of tooth-mounted attachments suitable for use with orthodontic appliances are also described in patents and patent applications assigned to Align Technology, Inc., including, for example, U.S. Pat. Nos. 6,309,215 and 6,830,450.

FIG. 7B illustrates a tooth repositioning system 710 including a plurality of appliances 712, 714, 716. The appliances 712, 714, 716 may be produced by a manufacturing system. The manufacturing system may include an end effector tool 162 (e.g., of one or more of FIGS. 1A-5) that is used to position the appliances and/or the molds used to form the appliances for one or more operations, as described herein. Any of the appliances described herein can be designed and/or provided as part of a set of a plurality of appliances used in a tooth repositioning system. Each appliance may be configured so a tooth-receiving cavity has a geometry corresponding to an intermediate or final tooth arrangement intended for the appliance. The patient's teeth can be progressively repositioned from an initial tooth arrangement to a target tooth arrangement by placing a series of incremental position adjustment appliances over the patient's teeth. For example, the tooth repositioning system 710 can include a first appliance 712 corresponding to an initial tooth arrangement, one or more intermediate appliances 714 corresponding to one or more intermediate arrangements, and a final appliance 716 corresponding to a target arrangement. A target tooth arrangement can be a planned final tooth arrangement selected for the patient's teeth at the end of all planned orthodontic treatment. Alternatively, a target arrangement can be one of some intermediate arrangements for the patient's teeth during the course of orthodontic treatment, which may include various different treatment scenarios, including, but not limited to, instances where surgery is recommended, where interproximal reduction (IPR) is appropriate, where a progress check is scheduled, where anchor placement is best, where palatal expansion is desirable, where restorative dentistry is involved (e.g., inlays, onlays, crowns, bridges, implants, veneers, and the like), etc. As such, it is understood that a target tooth arrangement can be any planned resulting arrangement for the patient's teeth that follows one or more incremental repositioning stages. Likewise, an initial tooth arrangement can be any initial arrangement for the patient's teeth that is followed by one or more incremental repositioning stages.

In some embodiments, the appliances 712, 714, 716 (or portions thereof) can be produced using indirect fabrication techniques, such as by thermoforming over a positive or negative mold. Indirect fabrication of an orthodontic appliance can involve producing a positive or negative mold of the patient's dentition in a target arrangement (e.g., by rapid prototyping, milling, etc.) and thermoforming one or more sheets of material over the mold in order to generate an appliance shell.

In an example of indirect fabrication, a mold of a patient's dental arch may be fabricated from a digital model of the dental arch, and a shell may be formed over the mold (e.g., by thermoforming a polymeric sheet over the mold of the dental arch and then trimming the thermoformed polymeric sheet). The fabrication of the mold may be performed by a rapid prototyping machine (e.g., a stereolithography (SLA) 3D printer). The rapid prototyping machine may receive digital models of molds of dental arches and/or digital models of the appliances 712, 714, 716 after the digital models of the appliances 712, 714, 716 have been processed by processing logic of a computing device, such as the computing device in FIG. 6. The processing logic may include hardware (e.g., circuitry, dedicated logic, programmable logic, microcode, etc.), software (e.g., instructions executed by a processing device), firmware, or a combination thereof. For example, one or more operations may be performed by a processing device executing a dental appliance generator 650.

To manufacture the molds, a shape of a dental arch for a patient at a treatment stage is determined based on a treatment plan. In the example of orthodontics, the treatment plan may be generated based on an intraoral scan of a dental arch to be modeled. The intraoral scan of the patient's dental arch may be performed to generate a three dimensional (3D) virtual model of the patient's dental arch (mold). For example, a full scan of the mandibular and/or maxillary arches of a patient may be performed to generate 3D virtual models thereof. The intraoral scan may be performed by creating multiple overlapping intraoral images from different scanning stations and then stitching together the intraoral images to provide a composite 3D virtual model. In other applications, virtual 3D models may also be generated based on scans of an object to be modeled or based on use of computer aided drafting techniques (e.g., to design the virtual 3D mold). Alternatively, an initial negative mold may be generated from an actual object to be modeled (e.g., a dental impression or the like). The negative mold may then be scanned to determine a shape of a positive mold that will be produced.

Once the virtual 3D model of the patient's dental arch is generated, a dental practitioner may determine a desired treatment outcome, which includes final positions and orientations for the patient's teeth. Processing logic may then determine a number of treatment stages to cause the teeth to progress from starting positions and orientations to the target final positions and orientations. The shape of the final virtual 3D model and each intermediate virtual 3D model may be determined by computing the progression of tooth movement throughout orthodontic treatment from initial tooth placement and orientation to final corrected tooth placement and orientation. For each treatment stage, a separate virtual 3D model of the patient's dental arch at that treatment stage may be generated. The shape of each virtual 3D model will be different. The original virtual 3D model, the final virtual 3D model and each intermediate virtual 3D model is unique and customized to the patient.

Accordingly, multiple different virtual 3D models (digital designs) of a dental arch may be generated for a single patient. A first virtual 3D model may be a unique model of a patient's dental arch and/or teeth as they presently exist, and a final virtual 3D model may be a model of the patient's dental arch and/or teeth after correction of one or more teeth and/or a jaw. Multiple intermediate virtual 3D models may be modeled, each of which may be incrementally different from previous virtual 3D models.

Each virtual 3D model of a patient's dental arch may be used to generate a unique customized physical mold of the dental arch at a particular stage of treatment. The shape of the mold may be at least in part based on the shape of the virtual 3D model for that treatment stage. The virtual 3D model may be represented in a file such as a computer aided drafting (CAD) file or a 3D printable file such as a stereolithography (STL) file. The virtual 3D model for the mold may be sent to a third party (e.g., clinician office, laboratory, manufacturing facility or other entity). The virtual 3D model may include instructions that will control a fabrication system or device in order to produce the mold with specified geometries.

A clinician office, laboratory, manufacturing facility or other entity may receive the virtual 3D model of the mold, the digital model having been created as set forth above. The entity may input the digital model into a rapid prototyping machine. The rapid prototyping machine then manufactures the mold using the digital model. One example of a rapid prototyping manufacturing machine is a 3D printer. 3D printing includes any layer-based additive manufacturing processes. 3D printing may be achieved using an additive process, where successive layers of material are formed in proscribed shapes. 3D printing may be performed using extrusion deposition, granular materials binding, lamination, photopolymerization, continuous liquid interface production (CLIP), or other techniques. 3D printing may also be achieved using a subtractive process, such as milling.

In some instances, stereolithography (SLA), also known as optical fabrication solid imaging, is used to fabricate an SLA mold. In SLA, the mold is fabricated by successively printing thin layers of a photo-curable material (e.g., a polymeric resin) on top of one another. A platform rests in a bath of a liquid photopolymer or resin just below a surface of the bath. A light source (e.g., an ultraviolet laser) traces a pattern over the platform, curing the photopolymer where the light source is directed, to form a first layer of the mold. The platform is lowered incrementally, and the light source traces a new pattern over the platform to form another layer of the mold at each increment. This process repeats until the mold is completely fabricated. Once all of the layers of the mold are formed, the mold may be cleaned and cured.

Materials such as a polyester, a co-polyester, a polycarbonate, a polycarbonate, a thermopolymeric polyurethane, a polypropylene, a polyethylene, a polypropylene and polyethylene copolymer, an acrylic, a cyclic block copolymer, a polyetheretherketone, a polyamide, a polyethylene terephthalate, a polybutylene terephthalate, a polyetherimide, a polyethersulfone, a polytrimethylene terephthalate, a styrenic block copolymer (SBC), a silicone rubber, an elastomeric alloy, a thermopolymeric elastomer (TPE), a thermopolymeric vulcanizate (TPV) elastomer, a polyurethane elastomer, a block copolymer elastomer, a polyolefin blend elastomer, a thermopolymeric co-polyester elastomer, a thermopolymeric polyamide elastomer, or combinations thereof, may be used to directly form the mold. The materials used for fabrication of the mold can be provided in an uncured form (e.g., as a liquid, resin, powder, etc.) and can be cured (e.g., by photopolymerization, light curing, gas curing, laser curing, crosslinking, etc.). The properties of the material before curing may differ from the properties of the material after curing.

Appliances may be formed from each mold and when applied to the teeth of the patient, may provide forces to move the patient's teeth as dictated by the treatment plan. The shape of each appliance is unique and customized for a particular patient and a particular treatment stage. In an example, the appliances 712, 714, 716 can be pressure formed or thermoformed over the molds. Each mold may be used to fabricate an appliance that will apply forces to the patient's teeth at a particular stage of the orthodontic treatment. The appliances 712, 714, 716 each have teeth-receiving cavities that receive and resiliently reposition the teeth in accordance with a particular treatment stage.

In one embodiment, a sheet of material is pressure formed or thermoformed over the mold. The sheet may be, for example, a sheet of polymeric (e.g., an elastic thermopolymeric, a sheet of polymeric material, etc.). To thermoform the shell over the mold, the sheet of material may be heated to a temperature at which the sheet becomes pliable. Pressure may concurrently be applied to the sheet to form the now pliable sheet around the mold. Once the sheet cools, it will have a shape that conforms to the mold. In one embodiment, a release agent (e.g., a non-stick material) is applied to the mold before forming the shell. This may facilitate later removal of the mold from the shell. Forces may be applied to lift the appliance from the mold. In some instances, a breakage, warpage, or deformation may result from the removal forces. Accordingly, embodiments disclosed herein may determine where the probable point or points of damage may occur in a digital design of the appliance prior to manufacturing and may perform a corrective action.

Additional information may be added to the appliance. The additional information may be any information that pertains to the appliance. Examples of such additional information includes a part number identifier, patient name, a patient identifier, a case number, a sequence identifier (e.g., indicating which appliance a particular liner is in a treatment sequence), a date of manufacture, a clinician name, a logo and so forth. For example, after determining there is a probable point of damage in a digital design of an appliance, an indicator may be inserted into the digital design of the appliance. The indicator may represent a recommended place to begin removing the polymeric appliance to prevent the point of damage from manifesting during removal in some embodiments.

In some embodiments, a library of removal methods/patterns may be established and this library may be referenced when simulating the removal of the aligner in the numerical simulation. Different patients or production technicians may tend to remove aligners differently, and there might be a few typical patterns. For example: 1) some patients lift from the lingual side of posteriors first (first left and then right, or vice versa), and then go around the arch from left/right posterior section to the right/left posterior section; 2) similar to #1, but some other patients lift only one side of the posterior and then go around the arch; 3) similar to #1, but some patients lift from the buccal side rather than the lingual side of the posterior; 4) some patients lift from the anterior incisors and pull hard to remove the aligner; 5) some other patients grab both lingual and buccal side of a posterior location and pull out both sides at the same time; 6) some other patients grab a random tooth in the middle. The library can also include a removal guideline provided by the manufacturer of the aligner. Removal approach may also depend on presence or absence of attachments on teeth as some pf the above method may result in more comfortable way of removal. Based on the attachment situation on each tooth, it can be determined how each patient would probably remove an aligner and adapt that removal procedure for that patient in that specific simulation.

After an appliance is formed over a mold for a treatment stage, the appliance is removed from the mold (e.g., automated removal of the appliance from the mold), and the appliance is subsequently trimmed along a cutline (also referred to as a trim line). The processing logic may determine a cutline for the appliance. The determination of the cutline(s) may be made based on the virtual 3D model of the dental arch at a particular treatment stage, based on a virtual 3D model of the appliance to be formed over the dental arch, or a combination of a virtual 3D model of the dental arch and a virtual 3D model of the appliance. The location and shape of the cutline can be important to the functionality of the appliance (e.g., an ability of the appliance to apply desired forces to a patient's teeth) as well as the fit and comfort of the appliance. For shells such as orthodontic appliances, orthodontic retainers and orthodontic splints, the trimming of the shell may play a role in the efficacy of the shell for its intended purpose (e.g., aligning, retaining, or positioning one or more teeth of a patient) as well as the fit of the shell on a patient's dental arch. For example, if too much of the shell is trimmed, then the shell may lose rigidity and an ability of the shell to exert force on a patient's teeth may be compromised. When too much of the shell is trimmed, the shell may become weaker at that location and may be a point of damage when a patient removes the shell from their teeth or when the shell is removed from the mold. In some embodiments, the cut line may be modified in the digital design of the appliance as one of the corrective actions taken when a probable point of damage is determined to exist in the digital design of the appliance.

On the other hand, if too little of the shell is trimmed, then portions of the shell may impinge on a patient's gums and cause discomfort, swelling, and/or other dental issues. Additionally, if too little of the shell is trimmed at a location, then the shell may be too rigid at that location. In some embodiments, the cutline may be a straight line across the appliance at the gingival line, below the gingival line, or above the gingival line. In some embodiments, the cutline may be a gingival cutline that represents an interface between an appliance and a patient's gingiva. In such embodiments, the cutline controls a distance between an edge of the appliance and a gum line or gingival surface of a patient.

Each patient has a unique dental arch with unique gingiva. Accordingly, the shape and position of the cutline may be unique and customized for each patient and for each stage of treatment. For instance, the cutline is customized to follow along the gum line (also referred to as the gingival line). In some embodiments, the cutline may be away from the gum line in some regions and on the gum line in other regions. For example, it may be desirable in some instances for the cutline to be away from the gum line (e.g., not touching the gum) where the shell will touch a tooth and on the gum line (e.g., touching the gum) in the interproximal regions between teeth. Accordingly, it is important that the shell be trimmed along a predetermined cutline.

FIG. 7C illustrates a method 750 of orthodontic treatment using a plurality of appliances, in accordance with embodiments. One or more of the plurality of appliances may be produced by a manufacturing system. The manufacturing system may include an end effector tool 162 (e.g., of one or more of FIGS. 1A-5) that is used to position the appliance and/or the mold used to form the appliance for one or more operations, as described herein. The method 750 can be practiced using any of the appliances or appliance sets described herein. In block 760, a first orthodontic appliance is applied to a patient's teeth to reposition the teeth from a first tooth arrangement to a second tooth arrangement. In block 770, a second orthodontic appliance is applied to the patient's teeth to reposition the teeth from the second tooth arrangement to a third tooth arrangement. The method 750 can be repeated as necessary using any suitable number and combination of sequential appliances to incrementally reposition the patient's teeth from an initial arrangement to a target arrangement. The appliances can be generated all at the same stage or in sets or batches (e.g., at the beginning of a stage of the treatment), or the appliances can be fabricated one at a time, and the patient can wear each appliance until the pressure of each appliance on the teeth can no longer be felt or until the maximum amount of expressed tooth movement for that given stage has been achieved. A plurality of different appliances (e.g., a set) can be designed and even fabricated prior to the patient wearing any appliance of the plurality. After wearing an appliance for an appropriate period of time, the patient can replace the current appliance with the next appliance in the series until no more appliances remain. The appliances are generally not affixed to the teeth and the patient may place and replace the appliances at any time during the procedure (e.g., patient-removable appliances). The final appliance or several appliances in the series may have a geometry or geometries selected to overcorrect the tooth arrangement. For instance, one or more appliances may have a geometry that would (if fully achieved) move individual teeth beyond the tooth arrangement that has been selected as the “final.” Such over-correction may be desirable to offset potential relapse after the repositioning method has been terminated (e.g., permit movement of individual teeth back toward their pre-corrected positions). Over-correction may also be beneficial to speed the rate of correction (e.g., an appliance with a geometry that is positioned beyond a desired intermediate or final position may shift the individual teeth toward the position at a greater rate). In such cases, the use of an appliance can be terminated before the teeth reach the positions defined by the appliance. Furthermore, over-correction may be deliberately applied to compensate for any inaccuracies or limitations of the appliance.

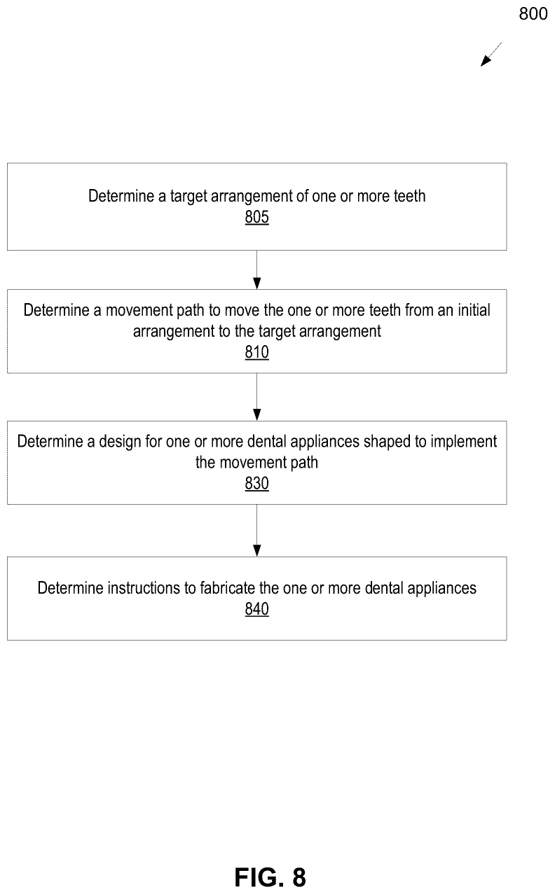

FIG. 8 illustrates a method 800 for designing an orthodontic appliance to be produced by direct or indirect fabrication, in accordance with embodiments. The method 800 can be applied to any embodiment of the orthodontic appliances described herein (e.g., dental appliances produced by a manufacturing system that includes an end effector tool 162 (e.g., of one or more of FIGS. 1A-5) that is used to position the aligner and/or the mold used to form the aligner for one or more operations, as described herein). Some or all of the blocks of the method 800 can be performed by any suitable data processing system or device, e.g., one or more processors configured with suitable instructions.

At block 805 a target arrangement of one or more teeth of a patient may be determined. The target arrangement of the teeth (e.g., a desired and intended end result of orthodontic treatment) can be received from a clinician in the form of a prescription, can be calculated from basic orthodontic principles, can be extrapolated computationally from a clinical prescription, and/or can be generated by a dental appliance generator 650 of FIG. 6. With a specification of the desired final positions of the teeth and a digital representation of the teeth themselves, the final position and surface geometry of each tooth can be specified to form a complete model of the tooth arrangement at the desired end of treatment.

In block 810, a movement path to move the one or more teeth from an initial arrangement to the target arrangement is determined. The initial arrangement can be determined from a mold or a scan of the patient's teeth or mouth tissue, e.g., using wax bites, direct contact scanning, x-ray imaging, tomographic imaging, sonographic imaging, and other techniques for obtaining information about the position and structure of the teeth, jaws, gums and other orthodontically relevant tissue. From the obtained data, a digital data set such as a 3D model for the patient's dental arch or arches can be derived that represents the initial (e.g., pretreatment) arrangement of the patient's teeth and other tissues. Optionally, the initial digital data set is processed to segment the tissue constituents from each other. For example, data structures that digitally represent individual tooth crowns can be produced. Advantageously, digital models of entire teeth can be produced, optionally including measured or extrapolated hidden surfaces and root structures, as well as surrounding bone and soft tissue.

Having both an initial position and a target position for each tooth, a movement path can be defined for the motion of each tooth. Determining the movement path for one or more teeth may include identifying a plurality of incremental arrangements of the one or more teeth to implement the movement path. In some embodiments, the movement path implements one or more force systems on the one or more teeth (e.g., as described below). In some embodiments, the movement paths are configured to move the teeth in the quickest fashion with the least amount of round-tripping to bring the teeth from their initial positions to their desired target positions. The tooth paths can optionally be segmented, and the segments can be calculated so that each tooth's motion within a segment stays within threshold limits of linear and rotational translation. In this way, the end points of each path segment can constitute a clinically viable repositioning, and the aggregate of segment end points can constitute a clinically viable sequence of tooth positions, so that moving from one point to the next in the sequence does not result in a collision of teeth.

In some embodiments, a force system to produce movement of the one or more teeth along the movement path is determined. A force system can include one or more forces and/or one or more torques. Different force systems can result in different types of tooth movement, such as tipping, translation, rotation, extrusion, intrusion, root movement, etc. Biomechanical principles, modeling techniques, force calculation/measurement techniques, and the like, including knowledge and approaches commonly used in orthodontia, may be used to determine the appropriate force system to be applied to the tooth to accomplish the tooth movement. In determining the force system to be applied, sources may be considered including literature, force systems determined by experimentation or virtual modeling, computer-based modeling, clinical experience, minimization of unwanted forces, etc.

The determination of the force system can include constraints on the allowable forces, such as allowable directions and magnitudes, as well as desired motions to be brought about by the applied forces. For example, in fabricating palatal expanders, different movement strategies may be desired for different patients. For example, the amount of force needed to separate the palate can depend on the age of the patient, as very young patients may not have a fully-formed suture. Thus, in juvenile patients and others without fully-closed palatal sutures, palatal expansion can be accomplished with lower force magnitudes. Slower palatal movement can also aid in growing bone to fill the expanding suture. For other patients, a more rapid expansion may be desired, which can be achieved by applying larger forces. These requirements can be incorporated as needed to choose the structure and materials of appliances; for example, by choosing palatal expanders capable of applying large forces for rupturing the palatal suture and/or causing rapid expansion of the palate. Subsequent appliance stages can be designed to apply different amounts of force, such as first applying a large force to break the suture, and then applying smaller forces to keep the suture separated or gradually expand the palate and/or arch.

The determination of the force system can also include modeling of the facial structure of the patient, such as the skeletal structure of the jaw and palate. Scan data of the palate and arch, such as X-ray data or 3D optical scanning data, for example, can be used to determine parameters of the skeletal and muscular system of the patient's mouth, to determine forces sufficient to provide a desired expansion of the palate and/or arch. In some embodiments, the thickness and/or density of the mid-palatal suture may be measured, or input by a treating professional. In other embodiments, the treating professional can select an appropriate treatment based on physiological characteristics of the patient. For example, the properties of the palate may also be estimated based on factors such as the patient's age—for example, young juvenile patients will typically require lower forces to expand the suture than older patients, as the suture has not yet fully formed.

In block 830, a design for one or more dental appliances shaped to implement the movement path is determined. In one embodiment, the one or more dental appliances are shaped to move the one or more teeth toward corresponding incremental arrangements. In one embodiment, the orthodontic application is determined by dental appliance generator 650 of FIG. 6. Determination of the one or more dental or orthodontic appliances, appliance geometry, material composition, and/or properties can be performed using a treatment or force application simulation environment. A simulation environment can include, e.g., computer modeling systems, biomechanical systems or apparatus, and the like. Optionally, digital models of the appliance and/or teeth can be produced, such as finite element models. The finite element models can be created using computer program application software available from a variety of vendors. For creating solid geometry models, computer aided engineering (CAE) or computer aided design (CAD) programs can be used, such as the AutoCAD® software products available from Autodesk, Inc., of San Rafael, CA. For creating finite element models and analyzing them, program products from a number of vendors can be used, including finite element analysis packages from ANSYS, Inc., of Canonsburg, PA, and SIMULIA(Abaqus) software products from Dassault Systèmes of Waltham, MA.

In block 840, instructions for fabrication of the one or more dental appliances are determined or identified. In some embodiments, the instructions identify one or more geometries of the one or more dental appliances. In some embodiments, the instructions identify slices to make layers of the one or more dental appliances with a 3D printer. In some embodiments, the instructions identify one or more geometries of molds usable to indirectly fabricate the one or more dental appliances (e.g., by thermoforming plastic sheets over the 3D printed molds). The dental appliances may include one or more of aligners (e.g., orthodontic aligners), retainers, incremental palatal expanders, attachment templates, and so on.

In one embodiment, instructions for fabrication of the one or more dental appliances are generated by dental appliance generator 650 of FIG. 6. The instructions can be configured to control a fabrication system or device to produce the orthodontic appliance with the specified orthodontic appliance. In some embodiments, the instructions are configured for manufacturing the orthodontic appliance using direct fabrication (e.g., stereolithography, selective laser sintering, fused deposition modeling, 3D printing, continuous direct fabrication, multi-material direct fabrication, etc.), in accordance with the various methods presented herein. In alternative embodiments, the instructions can be configured for indirect fabrication of the appliance, e.g., by 3D printing a mold and thermoforming a plastic sheet over the mold.

Method 800 may comprise additional blocks: 1) The upper arch and palate of the patient is scanned intraorally to generate three dimensional data of the palate and upper arch; and/or 2) The three dimensional shape profile of the appliance is determined to provide a gap and teeth engagement structures as described herein.

Although the above blocks show a method 800 of designing an orthodontic appliance in accordance with some embodiments, a person of ordinary skill in the art will recognize some variations based on the teaching described herein. Some of the blocks may comprise sub-blocks. Some of the blocks may be repeated as often as desired. One or more blocks of the method 800 may be performed with any suitable fabrication system or device, such as the embodiments described herein. Some of the blocks may be optional, and the order of the blocks can be varied as desired.

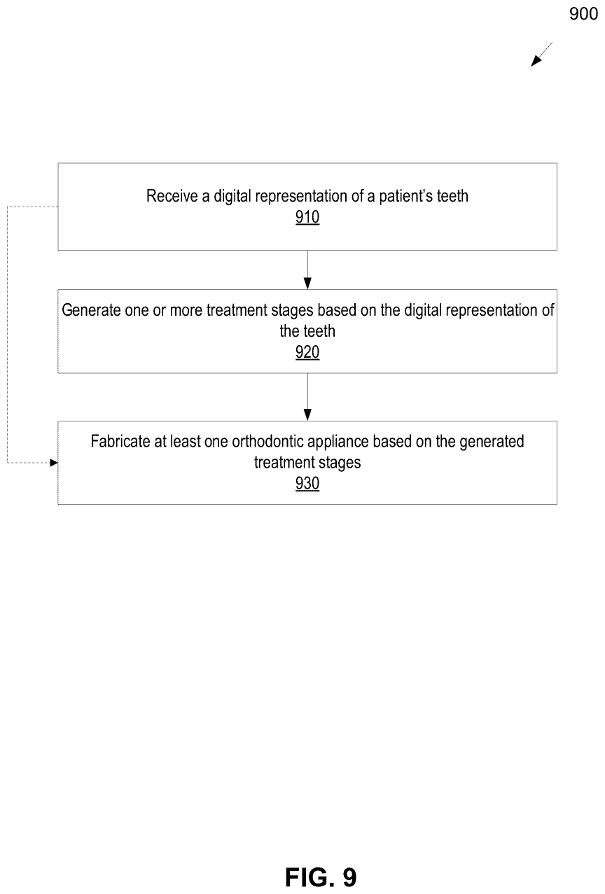

FIG. 9 illustrates a method 900 for digitally planning an orthodontic treatment and/or design or fabrication of an appliance, in accordance with embodiments. The dental appliance may be produced by a manufacturing system. The manufacturing system may include an end effector tool 162 (e.g., of one or more of FIGS. 1A-5) that is used to position the dental appliance and/or the mold used to form the dental appliance for one or more operations, as described herein. The method 900 can be applied to any of the treatment procedures described herein and can be performed by any suitable data processing system.

In block 910, a digital representation of a patient's teeth is received. The digital representation can include surface topography data for the patient's intraoral cavity (including teeth, gingival tissues, etc.). The surface topography data can be generated by directly scanning the intraoral cavity, a physical model (positive or negative) of the intraoral cavity, or an impression of the intraoral cavity, using a suitable scanning device (e.g., a handheld scanner, desktop scanner, etc.).

In block 920, one or more treatment stages are generated based on the digital representation of the teeth. The treatment stages can be incremental repositioning stages of an orthodontic treatment procedure designed to move one or more of the patient's teeth from an initial tooth arrangement to a target arrangement. For example, the treatment stages can be generated by determining the initial tooth arrangement indicated by the digital representation, determining a target tooth arrangement, and determining movement paths of one or more teeth in the initial arrangement necessary to achieve the target tooth arrangement. The movement path can be optimized based on minimizing the total distance moved, preventing collisions between teeth, avoiding tooth movements that are more difficult to achieve, or any other suitable criteria.

In block 930, at least one orthodontic appliance is fabricated based on the generated treatment stages. For example, a set of appliances can be fabricated, each shaped according a tooth arrangement specified by one of the treatment stages, such that the appliances can be sequentially worn by the patient to incrementally reposition the teeth from the initial arrangement to the target arrangement. The appliance set may include one or more of the orthodontic appliances described herein. The fabrication of the appliance may involve creating a digital model of the appliance to be used as input to a computer-controlled fabrication system. The appliance can be formed using direct fabrication methods, indirect fabrication methods, or combinations thereof, as desired. The fabrication of the appliance may include simultaneous thermoforming of multiple appliances (e.g., simultaneous thermoforming of multiple aligners via dental appliance manufacturing system 100, as described herein).

In some instances, staging of various arrangements or treatment stages may not be necessary for design and/or fabrication of an appliance. As illustrated by the dashed line in FIG. 9, design and/or fabrication of an orthodontic appliance, and perhaps a particular orthodontic treatment, may include use of a representation of the patient's teeth (e.g., receive a digital representation of the patient's teeth at block 910), followed by design and/or fabrication of an orthodontic appliance based on a representation of the patient's teeth in the arrangement represented by the received representation.

The preceding description sets forth numerous specific details such as examples of specific systems, components, methods, and so forth to provide a good understanding of several embodiments of the present disclosure. It will be apparent to one skilled in the art, however, that at least some embodiments of the present disclosure may be practiced without these specific details. In other instances, well-known components or methods are not described in detail or are presented in simple block diagram format to avoid unnecessarily obscuring the present disclosure. Thus, the specific details set forth are merely exemplary. Particular implementations may vary from these exemplary details and still be contemplated to be within the scope of the present disclosure.

The terms “over,” “under,” “between,” “disposed on,” and “on” as used herein refer to a relative position of one material layer or component with respect to other layers or components. For example, one layer disposed on, over, or under another layer may be directly in contact with the other layer or may have one or more intervening layers. Moreover, one layer disposed between two layers may be directly in contact with the two layers or may have one or more intervening layers. Similarly, unless explicitly stated otherwise, one feature disposed between two features may be in direct contact with the adjacent features or may have one or more intervening layers.

The words “example” or “exemplary” are used herein to mean serving as an example, instance or illustration. Any aspect or design described herein as “example’ or “exemplary” is not necessarily to be construed as preferred or advantageous over other aspects or designs. Rather, use of the words “example” or “exemplary” is intended to present concepts in a concrete fashion.

Reference throughout this specification to “one embodiment,” “an embodiment,” or “some embodiments” means that a particular feature, structure, or characteristic described in connection with the embodiment is included in at least one embodiment. Thus, the appearances of the phrase “in one embodiment,” “in an embodiment,” or “in some embodiments” in various places throughout this specification are not necessarily all referring to the same embodiment. In addition, the term “or” is intended to mean an inclusive “or” rather than an exclusive “or.” That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Also, the terms “first,” “second,” “third,” “fourth,” etc. as used herein are meant as labels to distinguish among different elements and can not necessarily have an ordinal meaning according to their numerical designation. When the term “about,” “substantially,” or “approximately” is used herein, this is intended to mean that the nominal value presented is precise within ±10%.

Although the operations of the methods herein are shown and described in a particular order, the order of operations of each method may be altered so that certain operations may be performed in an inverse order so that certain operations may be performed, at least in part, concurrently with other operations. In another embodiment, instructions or sub-operations of distinct operations may be in an intermittent and/or alternating manner.

It is to be understood that the above description is intended to be illustrative, and not restrictive. Many other embodiments will be apparent upon reading and understanding the above description. Although embodiments of the present disclosure have been described with reference to specific example embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense. The scope of the invention should, therefore, be determined with reference to the appended claims, along with the full scope of equivalents to which such claims are entitled.

What is claimed is:

1. An end effector tool comprising:
a fluid containing portion comprising a distal wall located at a first distal end of the fluid containing portion and one or more sidewalls extending from the distal wall, the distal wall and the one or more sidewalls partially enclosing an interior volume of the end effector tool, a fluid being disposed in the interior volume; and
an actuator configured to apply energy to the fluid to change the fluid between a liquid state and a solid state, wherein the fluid containing portion is to be placed over a dental product to cover the dental product with the fluid in the liquid state, and wherein the fluid is to secure the dental product responsive to the fluid being changed from the liquid state to the solid state.

2. The end effector tool of the claim 1, further comprising a membrane secured to the one or more sidewalls at a second distal end of the fluid containing portion, wherein the membrane, the distal wall, and the one or more sidewalls enclose the interior volume of the end effector tool, and wherein the membrane is configured to deform around the dental product to cause the fluid to cover the dental product.

3. The end effector tool of claim 1, wherein the fluid comprises a non-Newtonian fluid, and wherein the actuator comprises a mechanical vibration device configured to apply mechanical energy to the fluid to cause the fluid to be in the solid state.

4. The end effector tool of claim 3, wherein the non-Newtonian fluid comprises one or more of a rheopectic material, Bingham plastic material, thixotropic material, or pseudo plastic material.

5. The end effector tool of claim 1, wherein the fluid comprises a thermosensitive hydrogel, and wherein the actuator comprises a temperature adjustment device configured to adjust temperature of the fluid to cause the fluid to be in the solid state.

6. The end effector tool of claim 1, wherein the fluid containing portion is a cup, and wherein the end effector tool further comprises a shaft secured to the distal wall of the cup to adjust location of the cup to move the dental product.

7. The end effector tool of claim 1, wherein the dental product comprises a dental appliance that comprises one or more of a mold, aligner, palatal expander, or prefabricated template.

8. The end effector tool of claim 1, wherein the end effector tool comprises one or more reservoirs configured to receive a portion of the fluid that has been displaced responsive to covering the dental product with the fluid in the liquid state.

9. The end effector tool of claim 1, further configured to provide a vacuum pressure to secure the fluid in the liquid state in the interior volume of the end effector tool.

10. The end effector tool of claim 1, wherein a controller is configured to adjust an amount of the energy applied to the fluid based on one or more properties of the product.

11. A method comprising:
causing a fluid containing portion of an end effector tool to be placed over a dental product to cause fluid in a liquid state to cover the dental product, the fluid being disposed in the fluid containing portion;
causing an actuator to change the fluid from the liquid state to a solid state to secure the dental product; and
causing the actuator to change the fluid from the solid state to the liquid state to release the dental product.

12. The method of claim 11 further comprising causing the end effector tool to transport the dental product to location responsive to the causing of the actuator to change the fluid to the solid state and prior to the causing of the actuator to change the fluid to the liquid state.

13. The method of claim 11, wherein the fluid comprises a non-Newtonian fluid configured to change between the liquid state and the solid state, and wherein the actuator comprises a mechanical vibration device configured to apply mechanical energy to the fluid to change the fluid between the liquid state and the solid state.

14. The method of claim 11, wherein the fluid comprises a thermosensitive hydrogel configured to change between the liquid state and the solid state, and wherein the actuator comprises a temperature adjustment device configured to change temperature of the fluid to change the fluid between the liquid state and the solid state.

15. A system comprising:
a plate comprising an upper surface configured to receive a mold associated with a dental arch of a patient;
an end effector tool comprising:
a fluid containing portion configured to be placed over the mold to cause fluid in a liquid state to cover the mold, the fluid being disposed in the fluid containing portion; and
an actuator configured to: change the fluid from the liquid state to a solid state to secure the mold for transporting the mold; and responsive to the transporting of the mold, change the fluid from the solid state to the liquid state to place the mold on the plate; and
a thermoforming chamber configured to thermoform a heated sheet of plastic to the mold that is disposed on the plate to generate a thermoformed sheet of plastic to form a dental appliance.

16. The system of claim 15 further comprising:
a pallet configured to secure a sheet of plastic; and
a heating section configured to heat the sheet of plastic to generate the heated sheet of plastic.

17. The system of claim 15 further comprising a cutting tool configured to trim the dental appliance from the thermoformed sheet of plastic.

18. The system of claim 15, wherein the fluid comprises a non-Newtonian fluid configured to change between the liquid state and the solid state, and wherein the actuator comprises a mechanical vibration device configured to apply mechanical energy to the fluid to change the fluid between the liquid state and the solid state.

19. The system of claim 15, wherein the fluid comprises a thermosensitive hydrogel configured to change between the liquid state and the solid state, and wherein the actuator comprises a temperature adjustment device configured to change temperature of the fluid to change the fluid between the liquid state and the solid state.

20. The system of claim 15, wherein the end effector tool is configured to secure the dental appliance for one or additional operations.
